(19) United States
(12) Patent Application Publication
(10) Pub. No.: US 2026/0022284 A1
(43) Pub. Date: Jan. 22, 2026

(54) JANUS ABRASIVE PARTICLES AND SLURRY COMPOSITION FOR CHEMICAL MECHANICAL POLISHING CONTAINING THE SAME

(71) Applicant: Samsung Electronics Co., Ltd., Suwon-si (KR)

(72) Inventors: Nahyun An, Suwon-si (KR); Donghoon Kwon, Suwon-si (KR)

(21) Appl. No.: 19/269,678

(22) Filed: Jul. 15, 2025

(30) Foreign Application Priority Data
Jul. 16, 2024 (KR) 10-2024-0093861
Nov. 25, 2024 (KR) 10-2024-0170207

(51) Int. Cl. C09K 3/14

(52) U.S. Cl. CPC C09K 3/1436; C09K 3/1463

(57) ABSTRACT

A Janus abrasive particle may include a cocoon particle and a first coating portion. The cocoon particle may include a first region on its surface and a second region other than the first region, and the first coating portion may be provided on the first region of the cocoon particle and may include a material different from a material of the cocoon particle.

### CROSS-REFERENCE TO RELATED APPLICATIONS

This U.S. non-provisional application claims priority under 35 USC § 119 to Korean Patent Applications No. 10-2024-0093861, filed on Jul. 16, 2024, and Korean Patent Application No. 10-2024-0170207, filed on Nov. 25, 2024, in the Korean Intellectual Property Office, the disclosures of which are herein incorporated by reference in their entirety.

### FIELD

Janus abrasive particles used for chemical mechanical polishing (CMP) and a polishing slurry composition containing Janus abrasive particles are provided.

### BACKGROUND

As semiconductor devices have been diversified and highly integrated, technologies for forming finer patterns have been used. Accordingly, surface structures of semiconductor devices may become more complex, and interlayer planarity (or layer-to-layer flatness) in each process may act as an important factor to improve the precision of photolithography. In fabrication of a semiconductor device, a CMP process may be used as such a planarization technology. For example, a CMP process may be used in a process of planarizing an insulating layer for shallow trench isolation (STI) for insulation between an interlayer dielectric and a chip and a process of forming metal conductive layers such as an interconnection, a contact plug, or a via contact.

### SUMMARY

Exemplary embodiments relate to Janus abrasive particles used for chemical mechanical polishing (CMP) and a polishing slurry composition containing the same.

Exemplary embodiments provide a polishing slurry composition having high polishing efficiency without defects such as scratches in a chemical mechanical polishing (CMP) process.

Exemplary embodiments provide abrasive particles that may be used in a polishing slurry composition.

According to an exemplary embodiment, a Janus abrasive particle may include a cocoon particle and a first coating portion. The cocoon particle may include a first region and a second region other than the first region, and the first coating portion may be on the first region of the cocoon particle and may include a material different from a material of the cocoon particle.

According to an exemplary embodiment, a Janus abrasive particle may include a core particle having a dendrite structure and a first coating portion on a first region of the core particle. The first coating portion may include a material different from a material of the core particle. The core particle may comprise a pyroelectric material, and the first coating portion may comprise an abrasive material different from the core particle.

According to an exemplary embodiment, a slurry composition for chemical mechanical polishing may include Janus abrasive particles and a solvent in which the Janus abrasive particles are dispersed. Each of the Janus abrasive particles may include a cocoon particle or a core particle and a first coating portion. The cocoon particle may include a first region and a second region other than the first region, and the first coating portion may be on the first region of the cocoon particle and may include a material different from a material of the cocoon particle. The core particle may have a dendrite structure and may include a first coating portion on a first region of the core particle, wherein the first coating portion may include a material different from a material of the core particle.

### BRIEF DESCRIPTION OF DRAWINGS

FIG. 1 is a cross-sectional view illustrating a Janus abrasive particle according to an example embodiment.

FIG. 2 is a cross-sectional view illustrating a Janus abrasive particle according to an example embodiment.

FIGS. 3A to 3C are cross-sectional views illustrating Janus abrasive particles according to an example embodiment.

FIGS. 4A and 4B are cross-sectional views illustrating a Janus abrasive particle according to an example embodiment.

FIGS. 5A to 5D are cross-sectional views illustrating a Janus abrasive particle according to an example embodiment.

FIGS. 6A to 6D are cross-sectional views illustrating a Janus abrasive particle according to an example embodiment.

FIGS. 7A and 7B are cross-sectional views illustrating a Janus abrasive particle according to an example embodiment.

FIG. 8 is a cross-sectional view illustrating a Janus abrasive particle according to an example embodiment.

FIG. 9 is a cross-sectional view illustrating a Janus abrasive particle according to an example embodiment.

FIG. 10 is a flowchart illustrating a method of preparing a Janus abrasive particle according to an example embodiment.

FIG. 11 is a cross-sectional view sequentially illustrating a method of preparing a Janus abrasive particle according to an example embodiment.

FIG. 12 is a cross-sectional view sequentially illustrating a step of generating a cocoon particle in a method of preparing a Janus abrasive particle according to an example embodiment.

FIGS. 13A to 13C are cross-sectional views illustratively showing a process of forming a first coating portion while varying a contact area between cocoon particles and a substrate.

FIG. 14 is a cross-sectional view illustrating a Janus abrasive particle according to an example embodiment.

FIG. 15 is a cross-sectional view illustrating a Janus abrasive particle according to an example embodiment.

FIG. 16 is a cross-sectional view illustrating a Janus abrasive particle according to an example embodiment.

FIG. 17 is a cross-sectional view illustrating a Janus abrasive particle according to an example embodiment.

FIGS. 18A to 18C are cross-sectional views illustrating Janus abrasive particles according to an example embodiment.

FIG. 19 is a flowchart illustrating a method of preparing a Janus abrasive particle according to an example embodiment.

FIG. 20 is a cross-sectional view sequentially illustrating a method of preparing a Janus abrasive particle according to an example embodiment.

FIG. 21 is a flowchart illustrating a method of preparing a Janus abrasive particle.

FIG. 22 is a cross-sectional view sequentially illustrating a method of preparing a Janus abrasive particle according to an example embodiment.

FIG. 23 is a conceptual diagram illustrating the anisotropic arrangement of Janus abrasive particles in a chemical mechanical polishing slurry composition according to an example embodiment.

### DETAILED DESCRIPTION

Hereinafter, exemplary embodiments will be described in more detail with reference to the accompanying drawings.

Chemical Mechanical Polishing (CMP) is an essential planarization process in semiconductor manufacturing. In a CMP process, mechanical processing by abrasive particles between a target to be polished (hereinafter referred to as a “polishing target”) and a polishing pad of a CMP apparatus, along with chemical etching by a slurry composition, may be simultaneously performed. Specifically, CMP may be a process in which the surface of a polishing target is chemically altered by an acidic or basic solution to form a weakly bonded layer instantaneously, and then the formed layer is mechanically removed using abrasive particles. In the CMP process, the surface of the polishing target may be mechanically polished by applying pressure while supplying abrasive particles to the polishing target.

The present disclosure relates to a slurry composition used for chemical mechanical polishing of various films in semiconductor manufacturing processes. The slurry composition used in semiconductor manufacturing processes may include an insulating film slurry composition or a metal film slurry composition. In an exemplary embodiment, the insulating film slurry composition may be used to polish an oxide film such as a silicon oxide film in a semiconductor manufacturing process, to polish a silicon substrate surface after trench formation, or to polish an interlayer insulating film such as a gate insulating film. The metal film slurry composition may be used to polish wiring, electrodes, via/contact structures, or barrier metals in semiconductor manufacturing processes. Alternatively, the slurry composition may be used to polish films other than insulating or metal films, such as a polysilicon film.

Hereinafter, a Janus abrasive particle used in a chemical mechanical polishing slurry will be described first, followed by a description of a polishing slurry composition including the Janus abrasive particle.

A Janus abrasive particle may function as an abrasive particle for chemical mechanical polishing and may also have a surface with at least two different physical or chemical properties. As used herein, the surface of a Janus abrasive particle includes regions with different physical or chemical properties. Accordingly, in some embodiments, different types of chemical reactions may occur with Janus abrasive particles depending on the regions.

For example, in one embodiment of the present disclosure, the Janus abrasive particles may include regions that exhibit either hydrophobicity or hydrophilicity. The difference in hydrophilic and hydrophobic properties may influence the arrangement of the abrasive particles during the polishing process. For example, when the polishing slurry composition is applied to a target surface, the Janus abrasive particles may align in a specific direction, meaning they may be anisotropically arranged.

For example, if the polishing slurry composition is provided on a device surface that exhibits hydrophilicity or hydrophobicity, an attractive force may act between the portion of the abrasive particles that has the same property as the device surface. Due to this attractive force, the abrasive particles may be selectively adsorbed onto the surface in a specific orientation. As a result, the arrangement of the abrasive particles may be controlled.

Additionally, in some embodiments, since the surface of a Janus abrasive particle has different physical or chemical properties in different regions, the phenomenon of particle aggregation may be significantly reduced. For example, hydrophilic and hydrophobic particles have different surface energies, which may generate repulsive forces between adjacent particles. In the case of hydrophilic particles, various reactants located on the surface or interface of the particles may dissociate depending on pH, causing the surface of the particles to become partially negatively charged and achieving electrochemical stability.

Janus abrasive particles according to an exemplary embodiment may have various shapes. For example, the Janus abrasive particles may have either a cocoon shape or a single fine particle shape. Hereinafter, a Janus abrasive particle having a cocoon shape refers to an abrasive particle that is formed by the chemical and/or physical bonding of multiple fine particles, resulting in a composite structure. In contrast, a Janus abrasive particle having a single fine particle shape refers to an abrasive particle that consists of a single, independent particle without any chemical and/or physical bonding with other particles.

Hereinafter, a Janus abrasive particle having a cocoon shape will be described first, followed by a description of a Janus abrasive particle having a single fine particle shape.

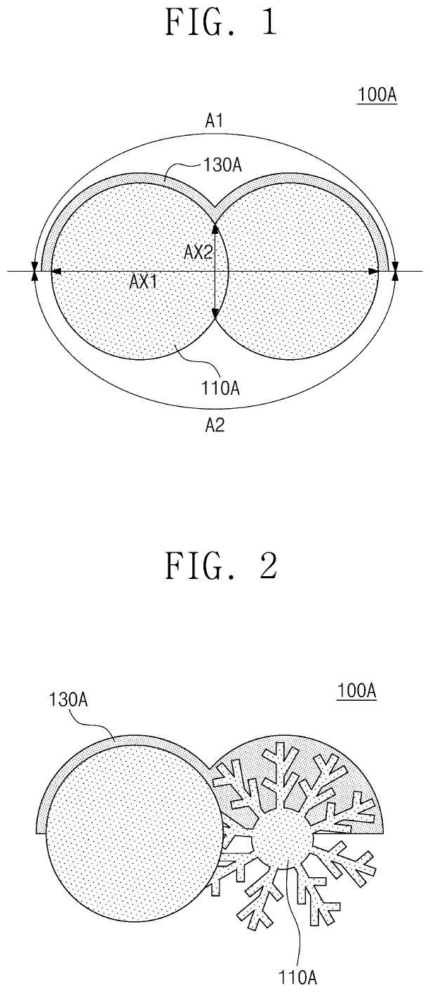

FIG. 1 is a cross-sectional view illustrating a Janus abrasive particle according to an example embodiment. FIG. 2 is a cross-sectional view illustrating a Janus abrasive particle according to an example embodiment.

Referring to FIGS. 1 and 2, a Janus abrasive particle 100A according to an exemplary embodiment may include a cocoon particle 110A. The cocoon particle 110A refers to an integrated particle having a cocoon-type shape formed by combining and/or synthesizing multiple individual abrasive particles. As will be described later, the combination and/or synthesis of individual abrasive particles forming the cocoon particle 110A may be achieved through a polymerization reaction of multiple particles.

The term “cocoon type,” as used herein, may refer to a complex shape excluding a spherical single fine particle shape unless otherwise specified. The cocoon-type particle may have an anisotropic shape, such as a branched structure or a curved structure, formed as a result of the combination and/or synthesis of individual abrasive particles. For example, the cocoon particle 110A may have an anisotropic shape with a major axis AX1 and a minor axis AX2 smaller than the major axis and extending transversely to the major axis. Additionally, a cocoon shape may refer to a structure in which multiple particles are arranged in a single-row or multi-row configuration similar to the body of a silkworm cocoon.

According to an embodiment of the present disclosure, the cocoon particle 110A may have a cocoon-type shape in which multiple spherical single particles are synthesized or combined. For convenience of explanation, the embodiment of the present disclosure illustrates an example in which two spherical particles are combined. However, the present disclosure is not limited thereto, and any shape conforming to the aforementioned cocoon type is possible.

According to an embodiment of the present disclosure, the Janus abrasive particle 100A may include a cocoon particle 110A and a first coating portion 130A. In FIG. 1, the boundary between the two spherical particles is shown for ease of description; however, this is only for explanatory purposes, and in reality, there may be no boundary between the combined spherical particles within the cocoon particle 110A. Additionally, in FIG. 1, the two spherical particles are depicted as having the same size, but the present disclosure is not limited thereto.

The cocoon particle 110A may form the main body of the Janus abrasive particle 100A and may be a particle in which multiple particles are combined and/or synthesized to take on the aforementioned cocoon-type shape. For example, as shown in FIGS. 1 and 2, the cocoon particle 110A may have a dumbbell shape formed by the combination of two particles. In FIGS. 1 and 2, the boundary between the two particles forming the cocoon particle 110A is shown for explanatory purposes; however, in reality, there may be no boundary between the combined particles within the cocoon particle 110A. Furthermore, in FIGS. 1 and 2, the combined particles are depicted as having the same size, but the present disclosure is not limited thereto.

The cocoon particle 110A may have an anisotropic shape with a major axis AX1, and a minor axis AX2.

The cocoon particle 110A may include silica (SiO₂), zirconia (ZrO₂), titania (TiO₂), ceria (CeO₂), alumina (Al₂O₃), surface-modified inorganic oxide particles, or combinations thereof. The cocoon particle 110A may include an inorganic oxide as a main polishing material. The inorganic oxide may include, for example, silica (SiO₂), zirconia (ZrO₂), titania (TiO₂), ceria (CeO₂), alumina (Al₂O₃), surface-modified inorganic oxide particles, or combinations thereof.

The cocoon particle 110A may include surface-modified inorganic oxide particles. The surface-modified inorganic oxide may be an inorganic oxide surface-modified with an organic material. The surface-modified inorganic oxide may be prepared by a coupling reaction on the surface of the inorganic oxide using a polymer graft. For example, it may be prepared by coupling a hydroxyl group of the inorganic oxide with a prepolymer having a terminal group reactive with the hydroxyl group. Examples of terminal groups reactive with hydroxyl groups include isocyanate groups, trialkoxysilyl groups, and chlorosilyl groups.

However, the method of preparing the surface-modified inorganic oxide is not limited thereto, and various other methods, such as radical polymerization reactions on the surface, may also be used. Examples of materials that may be used for the surface-modified inorganic oxide include cationic monomers and/or polymers, anionic monomers and/or polymers, or nonionic monomers and/or polymers.

However, the material of the cocoon particle 110A is not limited thereto and may include metal oxide particles, such as iron (Fe), aluminum (Al), lanthanum (La), manganese (Mn), zinc (Zn), calcium (Ca), magnesium (Mg), strontium (Sr), cobalt (Co), ruthenium (Ru), osmium (Os), rhodium (Rh), iridium (Ir), nickel (Ni), palladium (Pd), platinum (Pt), copper (Cu), silver (Ag), or gold (Au).

In an embodiment, the cocoon particle 110A may include a magnetic material, a piezoelectric material, and/or a photocatalytic material. In one embodiment, the cocoon particle 110A may include a pyroelectric material.

According to an embodiment of the present disclosure, the cocoon particle 110A may include the aforementioned materials and a polymerized polymer. The polymer may be used to form the cocoon particle 110A and may be polymerized from various functional monomers.

According to an embodiment of the present disclosure, the cocoon particle 110A may be formed by the combination of particles containing the same material. For example, the cocoon particle 110A may be formed by the combination of two particles containing the main polishing material. Additionally, the cocoon particle 110A may be formed by the combination of two particles containing a magnetic material, two particles containing a piezoelectric material, or two particles containing a photocatalytic material.

The surface of the cocoon particle 110A may include two regions with different chemical/physical properties, such as hydrophilicity and hydrophobicity. These regions may be referred to as a first region A1 and a second region A2, which is the remaining region excluding the first region A1. The first region A1 may be provided in an elongated direction along the major axis AX1 of the cocoon particle 110A, while the second region A2 may constitute the remaining portion of the surface except for the first region A1. Furthermore, the first region A1 and the second region A2 may be sequentially arranged along the minor axis AX2 and may not overlap each other.

In one embodiment, the cocoon particle 110A may include multiple combined particles, and at least some of these particles may have a dendritic structure. For example, as shown in FIG. 2, the cocoon particle 110A may have a structure in which two particles are combined, with one of them having a dendritic structure. The dendritic structure refers to a particle configuration in which multiple branches extend outward in all directions from a central spherical core. In other words, it represents a structure where multiple branches extend freely in all directions from the center of a spherical shape. Consequently, compared to a spherical particle, a particle with a dendritic structure may have an increased surface area available for friction and/or reaction with other particles.

The first coating portion 130A may be provided on the first region A1 of the cocoon particle 110A. That is, the first coating portion 130A may be provided on the first region A1 along the direction in which the major axis AX1 extends.

The first coating portion 130A may cover 50% or more but less than 100% of the surface of the cocoon particle 110A. In other words, the first region A1 may occupy 50% or more but less than 100% of the surface of the cocoon particle 110A.

The first coating portion 130A may include, as a main polishing material, silica (SiO₂), zirconia (ZrO₂), titania (TiO₂), ceria (CeO₂), alumina (Al₂O₃), surface-modified inorganic oxide particles, or combinations thereof. For example, the first coating portion 130A may include silica (SiO₂) and/or ceria (CeO₂). The cocoon particle 110A may further include a magnetic material, a piezoelectric material, and/or a photocatalytic material.

The first coating portion 130A may include a material that has chemical/physical properties different from those of the cocoon particle 110A. For example, when the cocoon particle 110A includes a hydrophobic material, the first coating portion 130A may include a material that is relatively more hydrophilic compared to the cocoon particle 110A. Conversely, when the cocoon particle 110A includes a hydrophilic material, the first coating portion 130A may include a material that is relatively more hydrophobic compared to the cocoon particle 110A.

Since different materials exhibit different levels of hydrophilicity and hydrophobicity, the abrasive particle may function as a Janus particle when the first coating portion 130A includes a material different from that of the cocoon particle 110A. For example, when the cocoon particle 110A includes silica and/or ceria, the first coating portion 130A may include a magnetic material, a piezoelectric material, and a photocatalytic material. Alternatively, when the cocoon particle 110A includes a magnetic material, a piezoelectric material, and a photocatalytic material, the first coating portion 130A may include silica and/or ceria.

When ceria is included in the first coating portion 130A, it may enhance the removal selectivity for a specific material of the polishing target. When ceria is coated on an abrasive particle, the ceria particles may exist in an ionized form (e.g., Ce³⁺ state) in the abrasive slurry composition 10 (see FIG. 23). These ceria abrasive particles may exhibit a higher polishing rate for a silicon oxide insulating layer than for a silicon nitride insulating layer. This may result from the increased reaction rate between Ce³⁺ and Si—O⁻, leading to the formation of a large number of Ce—O—Si bonds. Consequently, the polishing rate of the silicon oxide insulating layer may increase. Silica may also perform the same function as ceria.

A pyroelectric material may be included in at least one of the first coating portion 130A and the cocoon particle 110A. For example, the cocoon particle 110A may include hydroxyapatite (Ca₁₀(PO₄)₆(OH)₂), barium titanate (BaTiO₃), bismuth ferrite (BiFeO₃), potassium niobate (KNbO₃), dibutylammonium perrhenate ((C₆H₁₄N₂) ReO₄), lead zirconate (PbZrO₃), lead titanate (PbTiO₃), triglycine sulfate (C—H₆O₄S), lithium tantalate (LiTaO₃), lithium niobate (LiNbO₃), polyvinylidene fluoride (PVDF; (C₂H₂F₂)n), polyvinylidene fluoride-trifluoroethylene copolymer (PVDF-TrFE; (C₂H₂F₂)n-(C₂H₂F₄O₂)m), erbium-doped PVDF (Er-doped PVDF), PVDF-methylammonium lead iodide (PVDF-MAPbI₃; (C₂H₂F₂)n-(CH₃NH₃PbI₃)), fluorapatite-gelatin mixture ((Ca₅(PO₄)₃F+ gelatin), polyvinyl chloride (PVC; (C₂H₃Cl)n), polyacrylonitrile (PAN; (C₃H₃N)n), hafnium oxide (HfO₂), or combinations thereof.

Here, the values of ‘n’ and ‘m’ for the materials listed in the descriptions, such as polyvinylidene fluoride (PVDF), polyvinylidene fluoride-trifluoroethylene copolymer (PVDF-TrFE), and polyvinylidene fluoride-methylammonium lead iodide (PVDF-MAPbI₃), may encompass the entire range of values typically used in industry. These values may be commonly within the molecular weight and polymerization degree ranges that are widely utilized for the corresponding materials in various applications. For example, n and m may range from several tens to several thousand, depending on the specific application, with n typically ranging from 50 to 5,000 and m corresponding to similar molecular weight ranges. These ranges may be considered to be within the standard scope of the materials as typically used in industry.

In an embodiment, if the cocoon particle 110A includes a magnetic material, the first coating portion 130A may not include a magnetic material. Conversely, in an embodiment, if the cocoon particle 110A does not include a magnetic material, the first coating portion 130A may include a magnetic material. Additionally, both the cocoon particle 110A and the first coating portion 130A may include a pyroelectric material.

When at least one of the cocoon particle 110A and the first coating portion 130A includes a pyroelectric material, the pyroelectric material contained in the Janus abrasive particle 100A may release excess electrons due to temperature changes. In some embodiments, the excess electrons emitted from the pyroelectric material may be transferred to the main polishing material (e.g., ceria (CeO₂) and/or silica (SiO₂)) contained in the Janus abrasive particle 100A. For example, if the main polishing material is CeO₂, Ce⁴⁺ may receive excess electrons from the pyroelectric material and be converted into Ce³⁺, thereby improving the polishing rate.

In one embodiment, the pyroelectric material included in the cocoon particle 110A or the first coating portion 130A may have a dendritic structure. For example, as shown in FIG. 2, one of the multiple particles forming the cocoon particle 110A may be a pyroelectric material with a dendritic structure. In this case, the surface area of the pyroelectric material may increase. As the surface area increases, the contact area with the polishing pad during the chemical mechanical polishing process may expand, thereby increasing the temperature rise rate due to friction. Additionally, the increase in surface area may enhance the area available for electron emission. As a result, the polishing rate may improve.

A magnetic material may be included in at least one of the first coating portion 130A and the cocoon particle 110A. For example, the first coating portion 130A may include magnetic materials such as Fe₃O₄, Fe₂O₃, or Co₂Fe₃O₄. In an embodiment, if the first coating portion 130A contains a magnetic material, the cocoon particle 110A may not include a magnetic material. Conversely, in an embodiment, if the first coating portion 130A does not contain a magnetic material, the cocoon particle 110A may include a magnetic material, thereby imparting magnetism to the entire cocoon particle 110A. Additionally, in an embodiment, both the cocoon particle 110A and the first coating portion 130A may include a magnetic material.

When at least one of the cocoon particle 110A and the first coating portion 130A includes a magnetic material, the Janus abrasive particle 100A may be manufactured using magnetism. For example, magnetism may facilitate the directional arrangement control of the Janus abrasive particle 100A. That is, the behavior of the Janus abrasive particle 100A may be controlled by a magnetic field, thereby simplifying its fabrication.

A piezoelectric material may be included in at least one of the first coating portion 130A and the cocoon particle 110A. For example, the first coating portion 130A may include piezoelectric materials such as BaTiO₃ or ZnO. In an embodiment, if the first coating portion 130A contains a piezoelectric material, the cocoon particle 110A may not include a piezoelectric material. Conversely, in an embodiment, if the first coating portion 130A does not contain a piezoelectric material, the cocoon particle 110A may include a piezoelectric material.

A piezoelectric material can generate polarization when subjected to mechanical stress, thereby producing an instantaneous voltage. In other words, a piezoelectric material can generate excess electrons when exposed to an external stimulus such as vibration. When the Janus abrasive particle 100A includes a piezoelectric material, the main polishing material (e.g., ceria (CeO₂) and/or silica (SiO₂)) may receive excess electrons generated by the piezoelectric material. For example, if the main polishing material is CeO₂, Ce⁴⁺ may receive excess electrons from the piezoelectric material and be converted into Ce³⁺, thereby improving the polishing rate.

In one embodiment, at least one of the cocoon particle 110A and the first coating portion 130A may include a pyroelectric material, and the cocoon particle 110A may include a piezoelectric material. For example, the first coating portion 130A may include the main polishing material, while the cocoon particle 110A may include both a pyroelectric material and a piezoelectric material. In an embodiment, when the Janus abrasive particle 100A contains both a pyroelectric material and a piezoelectric material, the movement of excess electrons emitted from the pyroelectric and piezoelectric materials during the polishing process may become more active. Consequently, the polishing rate may improve.

A photocatalytic material may be included in at least one of the first coating portion 130A and the cocoon particle 110A. For example, the first coating portion 130A may include photocatalytic materials such as TiO₂, CuO, or CdS. In an embodiment, if the first coating portion 130A contains a photocatalytic material, the cocoon particle 110A may not include a photocatalytic material. Conversely, in an embodiment, if the first coating portion 130A does not contain a photocatalytic material, the cocoon particle 110A may include a photocatalytic material.

A photocatalytic material can generate electron-hole pairs on its surface by emitting excess electrons when exposed to light. The generated electron-hole pairs may react with substances adsorbed on the surface, thereby promoting oxidation-reduction reactions. Accordingly, when the Janus abrasive particle 100A includes a photocatalytic material, the main polishing material (e.g., ceria (CeO₂) and/or silica (SiO₂)) may receive excess electrons generated by the photocatalytic material. For example, if the main polishing material is CeO₂, Ce⁴⁺ may receive excess electrons from the photocatalytic material and be converted into Ce³⁺, thereby improving the polishing rate.

In the embodiments described above, two particles of approximately the same size are combined to form a single cocoon particle. However, the present disclosure is not limited thereto, and cocoon particles may be formed by combining particles of various sizes.

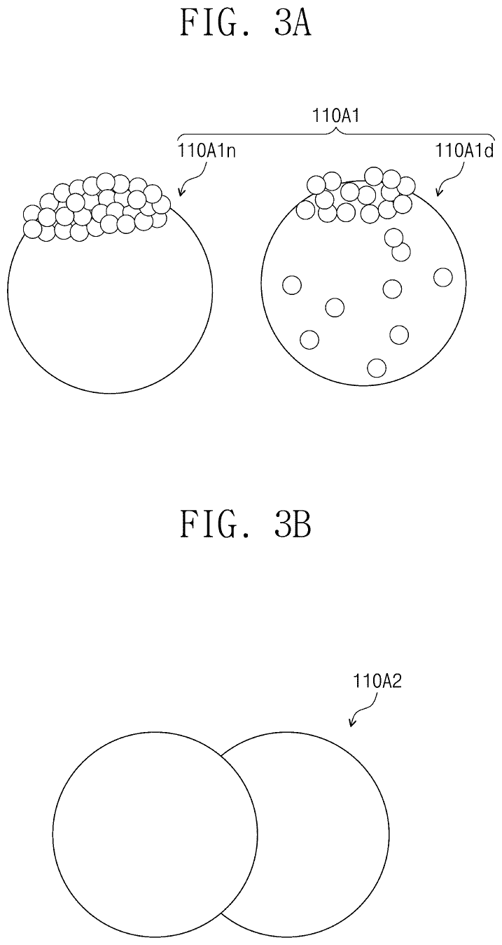

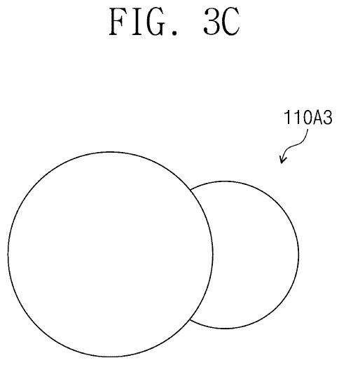

FIGS. 3A to 3C are cross-sectional views illustrating various shapes of cocoon particles according to an embodiment of the present disclosure.

Referring to FIGS. 3A to 3C, the cocoon particle 110A may have a half-raspberry-like shape (110A1), a dumbbell-like shape (110A2), or an egg-like shape (110A3). Hereinafter, the half-raspberry-like, dumbbell-like, and egg-like cocoon particles will be described in more detail.

The half-raspberry-like cocoon particle 110A1 may have a structure in which multiple smaller spherical particles are anisotropically combined and/or synthesized onto a relatively larger particle. The diameter ratio between the larger particle and the smaller particles may vary, for example, between 1:0.1 and 1:0.3, or any range therein. Additionally, the shape of the larger particle may vary and may be a spherical particle or a particle with a dendritic structure.

The half-raspberry-like cocoon particle 110A1 may be classified into a normal type and a dispersed type depending on how the smaller particles are combined and/or synthesized. A normal-type half-raspberry-like cocoon particle 110A1n may have a structure in which multiple smaller spherical particles are anisotropically combined and/or synthesized on a specific region of a larger spherical particle. A dispersed-type half-raspberry-like cocoon particle 110A1d may have a structure in which multiple smaller spherical particles are irregularly combined and/or synthesized on various regions of the larger spherical particle.

The dumbbell-like cocoon particle 110A2 may have a structure in which multiple spherical particles of similar sizes are sequentially combined and/or synthesized in one direction. The diameter ratio between the two similar-sized particles may range from 1:0.8 to 1:1, or any range therein.

The egg-like cocoon particle 110A3 may have a structure in which multiple spherical particles of different sizes are sequentially combined and/or synthesized in one direction. Additionally, overlapping regions may exist where the different-sized particles are combined and/or synthesized. The size ratio between the larger and smaller particles may range from 1:0.3 to 1:0.8, or any range therein.

In one embodiment of the present disclosure, the dumbbell-like cocoon particle 110A2 and the egg-like cocoon particle 110A3 are illustrated as having a structure in which multiple spherical particles are combined and/or synthesized in a linear arrangement in one direction. However, the present disclosure is not limited thereto, and the cocoon particle 110A may have various shapes extending in multiple directions. For example, the cocoon particle 110A may have an anisotropic shape in which multiple spherical particles are combined and/or synthesized in a zigzag manner.

For explanatory convenience, the dumbbell-like cocoon particle 110A2 is illustrated as a reference in the embodiment of the present disclosure, but the present disclosure is not limited thereto. For example, the Janus abrasive particle 100A may include a half-raspberry-like cocoon particle 110A1 and/or an egg-like cocoon particle 110A3.

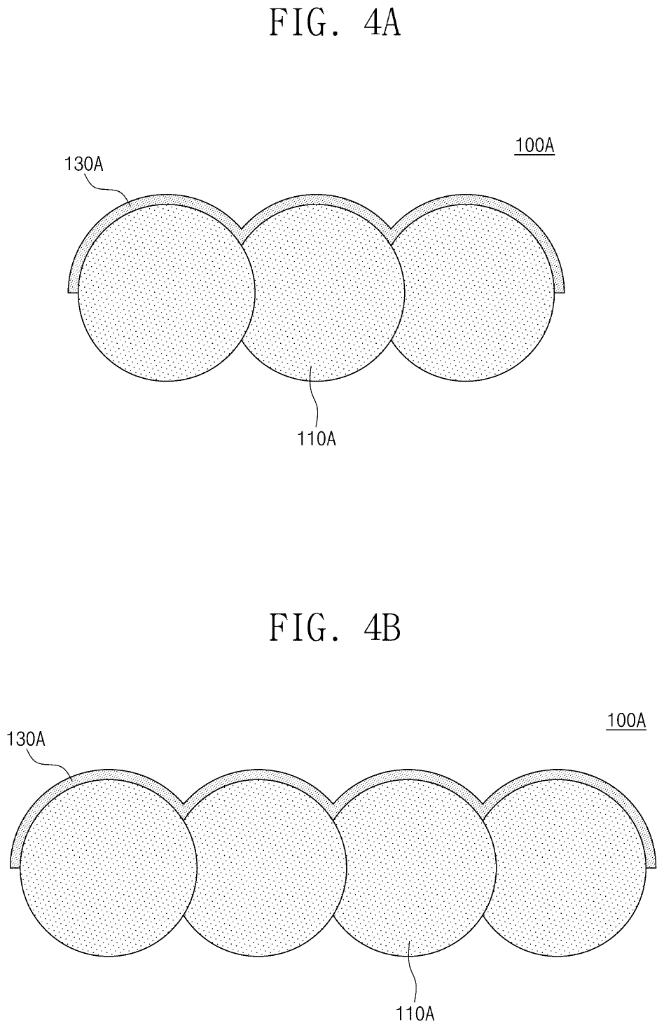

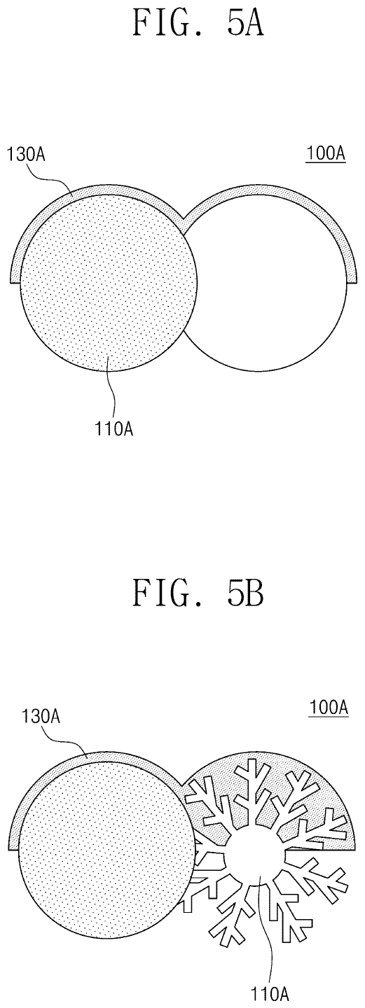

FIGS. 4A and 4B are cross-sectional views illustrating a Janus abrasive particle according to an embodiment of the present disclosure. The following embodiments will focus on aspects different from those described above to avoid redundancy.

Referring to FIGS. 4A and 4B, the Janus abrasive particle 100A may include a cocoon particle 110A, in which three or more particles are combined, and a first coating portion 130A provided on the surface of the cocoon particle 110A.

Three or more particles may be combined and/or synthesized to form the cocoon particle 110A. In one embodiment of the present disclosure, the Janus abrasive particle 100A may include three combined particles as illustrated in FIG. 4A and four combined particles as illustrated in FIG. 4B. Furthermore, although not illustrated, the Janus abrasive particle 100A may include more than four particles.

In FIGS. 4A and 4B, the multiple particles are illustrated as being combined in a straight line. However, the present disclosure is not limited thereto, and the particles may be combined in a bent or zigzag shape.

All three or four particles forming the cocoon particle 110A may contain the same material, such as a main polishing material (e.g., silica or ceria), a magnetic material, a piezoelectric material, or a photocatalytic material. In this case, the first coating portion 130A may include a material different from that of the cocoon particle 110A to have different physical/chemical properties. For example, if the cocoon particle 110A contains a magnetic material, the first coating portion 130A may include the main polishing material.

In the above-described embodiments, the combined particles forming the cocoon particle were described as containing the same material, but the present disclosure is not limited thereto. At least some of the combined particles forming the cocoon particle may contain a different material than the others.

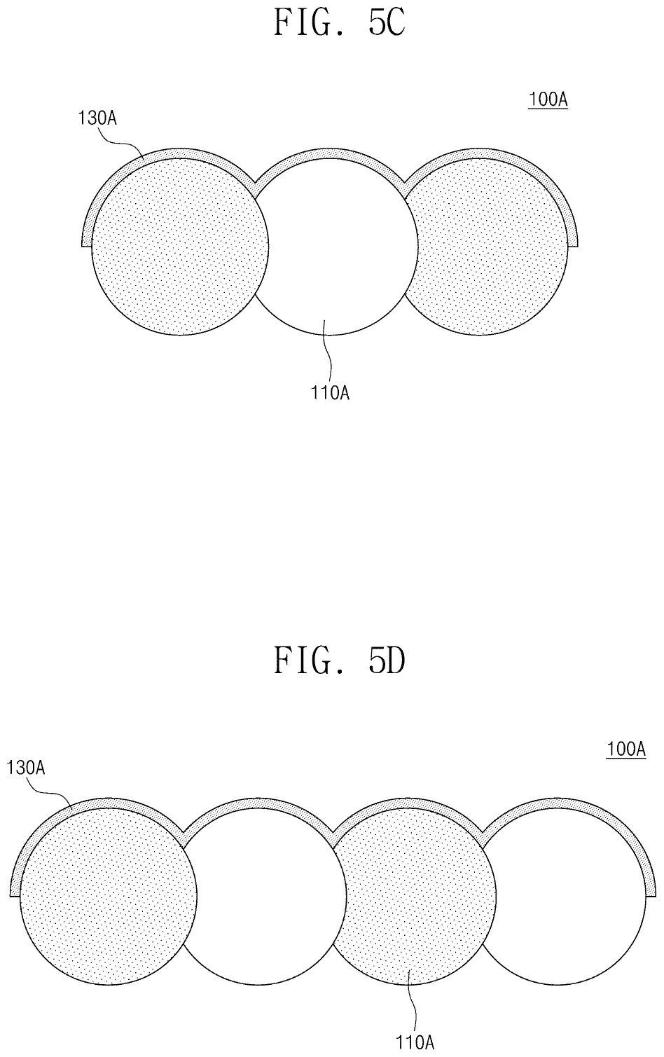

FIGS. 5A to 5D are cross-sectional views illustrating Janus abrasive particles 100A according to an embodiment of the present disclosure.

Referring to FIGS. 5A to 5D, the cocoon particle 110A may include multiple particles, with at least some of them containing different types of materials from the remaining particles. More specifically, as shown in FIG. 5A, the cocoon particle 110A may include two particles, each containing a different material.

In one embodiment of the present disclosure, one of the particles forming the cocoon particle 110A may be a main polishing material, a pyroelectric material, a magnetic material, a piezoelectric material, or a photocatalytic material, while the other particle may be one of the remaining materials.

Referring to FIG. 5B, the cocoon particle 110A may include two particles, each having different shapes and materials. For example, one of the two particles forming the cocoon particle 110A may be the main polishing material, while the other particle may be a pyroelectric material with a dendritic structure.

Referring to FIG. 5C, the cocoon particle 110A may include three particles, at least some of which contain two different types of materials. For example, the three particles may include two of the same type and one of a different type. In one embodiment of the present disclosure, among the three particles forming the cocoon particle 110A, two may include a main polishing material, a magnetic material, a piezoelectric material, or a photocatalytic material, while the remaining particle may include one of the other materials. For example, two silica particles and one magnetic material particle may be combined and/or synthesized to form the cocoon particle 110A.

Referring to FIG. 5D, the cocoon particle 110A may include four particles, at least some of which contain two different types of materials. For example, among the four particles, two may contain the same material, while the other two may contain a different material.

In the embodiments of FIGS. 5A to 5D, the number of particles is illustrated as two to four, but the present disclosure is not limited thereto. For example, five or more particles may be combined and/or synthesized to form the cocoon particle 110A.

The Janus abrasive particle 100A according to an embodiment of the present disclosure may include various combinations of particle shapes and materials.

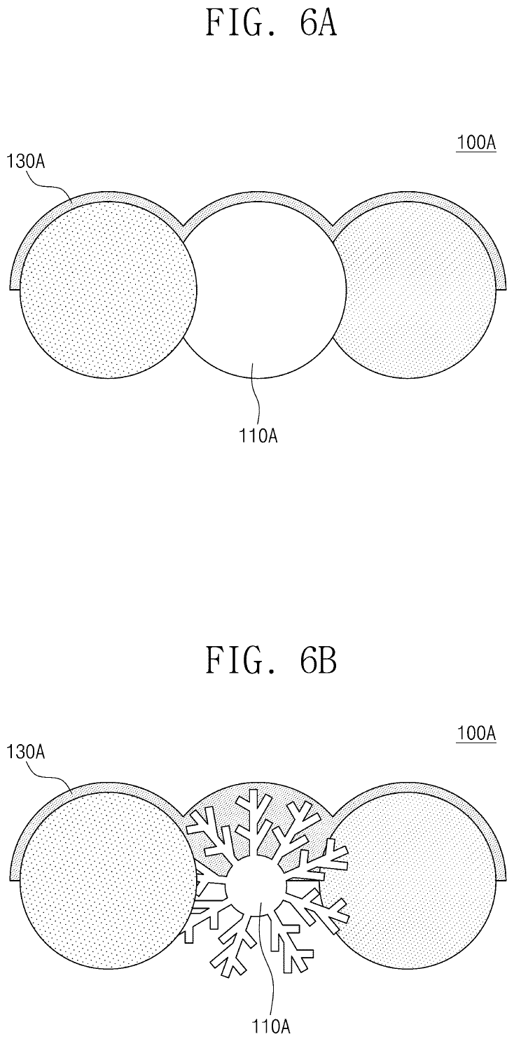

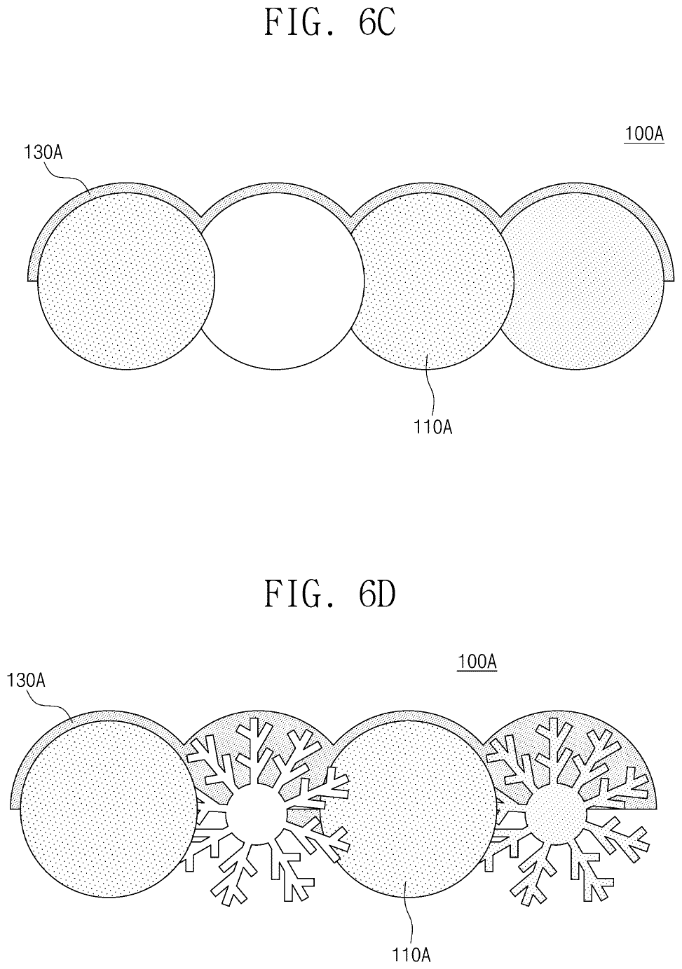

FIGS. 6A to 6D are cross-sectional views illustrating Janus abrasive particles according to an embodiment of the present disclosure.

Referring to FIGS. 6A to 6D, at least some of the particles forming the cocoon particle may contain three or more types of different materials. For example, as shown in FIGS. 6A and 6B, the cocoon particle may include three particles, each containing a different material. For instance, the cocoon particle 110A may be formed by combining and/or synthesizing one ceria particle, one photocatalytic material particle, and one magnetic material particle.

Similarly, as shown in FIGS. 6C and 6D, the cocoon particle 110A may include four particles, each containing three or more different types of materials. That is, among the four particles, two may contain the same material, while the other two may each contain a material different from the first two. For example, as illustrated in FIG. 6C, one ceria particle, one photocatalytic material particle, and two magnetic material particles may be combined and/or synthesized to form the cocoon particle 110A. As another example, as illustrated in FIG. 6D, two ceria particles, one pyroelectric material particle with a dendritic structure, and one magnetic material particle with a dendritic structure may be combined and/or synthesized to form the cocoon particle 110A.

In the embodiments of FIGS. 6A to 6D, the number of particles is illustrated as three or four, but the present disclosure is not limited thereto. For example, five or more particles may be combined and/or synthesized to form the cocoon particle 110A. Furthermore, multiple particles containing four or more different types of materials may be combined and/or synthesized to form the cocoon particle 110A.

In one embodiment of the present disclosure, the first region A1 of the Janus abrasive particle 100A, where the first coating portion 130A is provided, may be defined differently from the above-described embodiments.

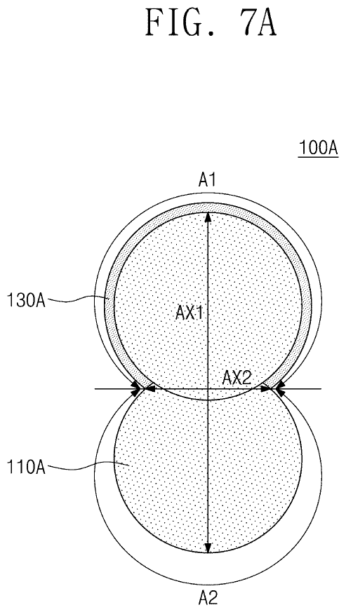

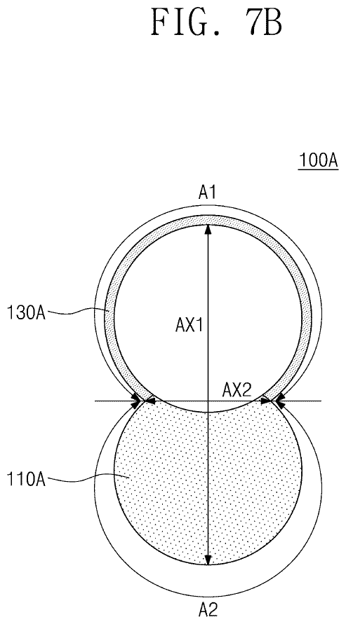

FIGS. 7A and 7B are cross-sectional views illustrating a Janus abrasive particle according to an embodiment of the present disclosure.

Referring to FIGS. 7A and 7B, the first region A1 and the second region A2 on the surface of the cocoon particle 110A may be sequentially arranged in the direction of the major axis AX1. Additionally, the first coating portion 130A may be provided on the first region A1 in the direction in which the minor axis AX2 extends.

Referring to FIG. 7A, two particles may be combined and/or synthesized to form the cocoon particle 110A. The particles forming the cocoon particle 110A may contain the same material.

Referring to FIG. 7B, two particles may be combined and/or synthesized to form the cocoon particle 110A, with the two particles containing different materials. The two particles may include various materials. For example, one of the two particles may contain a magnetic material. When at least some of the particles forming the cocoon particle 110A contain a magnetic material, it becomes possible to arrange the cocoon particle 110A in a specific direction using magnetism. By arranging the cocoon particle 110A in a specific direction, it is also possible to form the first coating portion 130A at a designated location.

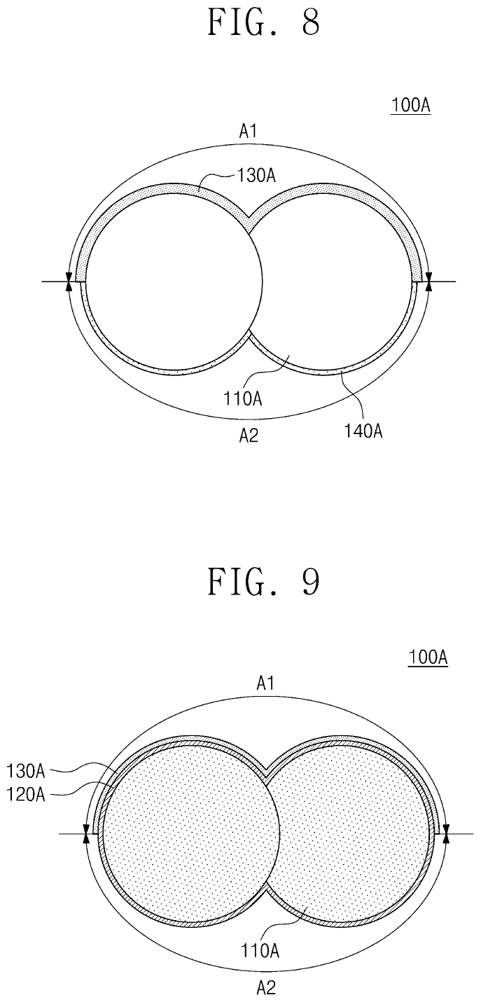

FIG. 8 is a cross-sectional view illustrating a Janus abrasive particle according to an embodiment of the present disclosure.

Referring to FIG. 8, a third coating portion 140A may be provided on the second region A2 of the cocoon particle 110A.

The third coating portion 140A may include a material different from that of the cocoon particle 110A. For example, the third coating portion 140A may include a magnetic material. In this case, the first coating portion 130A and the cocoon particle 110A may not include a magnetic material. For example, one of the cocoon particle 110A and the first coating portion 130A may include silica and/or ceria particles, while the other may include a piezoelectric material or a photocatalytic material.

In one embodiment of the present disclosure, an additional coating portion may be provided to control the behavior of the Janus abrasive particle 100A, such as aligning it in a specific direction.

Referring to FIG. 9, a cross-sectional view illustrating a Janus abrasive particle according to an embodiment of the present disclosure is shown.

Referring to FIG. 9, the Janus abrasive particle 100A may include a cocoon particle 110A, a second coating portion 120A, and a first coating portion 130A.

The second coating portion 120A may be provided over the entire surface of the cocoon particle. That is, the second coating portion 120A may be formed on both the first region A1 and the second region A2 of the cocoon particle. The first coating portion 130A may be provided on the second coating portion 120A corresponding to the first region A1.

The second coating portion 120A may include a material exhibiting hydrophilicity or hydrophobicity. The second coating portion 120A may include a hydrophilic material. For example, the second coating portion 120A may include a polymer having a composition ratio of hydrophilic functional groups (—NH₃, —COOH, —OH, etc.) of about 30% or more of the total.

The second coating portion 120A and the first coating portion 130A may be provided on the surface of the cocoon particle 110A with substantially the same thickness; however, the present disclosure is not limited thereto. For example, the second coating portion 120A may be provided on the surface of the cocoon particle 110A with a thinner thickness than the first coating portion 130A. The thickness of the second coating portion 120A and the first coating portion 130A may vary depending on the polishing environment and/or the polishing target of the Janus abrasive particle 100A.

In one embodiment of the present disclosure, the second coating portion 120A may include a hydrophilic material to exhibit hydrophilicity. The second coating portion 120A is covered by the first coating portion 130A in the region corresponding to the first region A1, so that the surface of the second coating portion 120A is exposed only in the region corresponding to the second region A2. Accordingly, the hydrophilic region may correspond to a region where the second coating portion 120A is provided on the surface of the cocoon particle 110A but is not covered by the first coating portion 130A, thus exposing the second coating portion 120A to an external environment. The hydrophilic region may vary depending on the area of the surface of the cocoon particle 110A covered by the first coating portion 130A and the second coating portion 120A.

The hydrophilic region may allow abrasive particles to be arranged in a specific direction, that is, anisotropically, when a polishing target is polished using a polishing slurry composition. For example, when the Janus abrasive particles 100A are provided on a device surface having hydrophilicity, an attractive force may act between the hydrophilic region of the Janus abrasive particles 100A and the surface of the device. Due to this attractive force, the particles may be adsorbed in a specific direction onto the hydrophilic surface of the device, enabling controlled arrangement.

For example, when the polishing pad of a chemical mechanical polishing apparatus has hydrophilicity, the Janus abrasive particles 100A may be easily adsorbed onto the hydrophilic polishing pad (not shown) of the chemical mechanical polishing apparatus. Specifically, when the Janus abrasive particles 100A in the polishing slurry composition are adsorbed onto the polishing pad, they may be arranged in a predetermined direction based on their characteristics. The hydrophilic polishing pad (not shown) may be formed of hydrophilic polyurethane with a composition ratio of hydrophilic functional groups (—NH₃, —COOH, —OH, etc.) of about 30% or more, for example, 40% or 50% or more, of the total.

Additionally, in one embodiment of the present disclosure, the second coating portion 120A may include a hydrophobic material. For example, the second coating portion 120A may include a polymer having a composition ratio of hydrophilic functional groups (—NH₃, —COOH, —OH, etc.) of about 30% or less, for example, 20% or 10% or less, of the total.

The second coating portion 120A may include a hydrophobic material to form a hydrophobic region. The hydrophobic region may correspond to a region where the second coating portion 120A is provided on the surface of the cocoon particle 110A but is not covered by the first coating portion 130A, thus exposing the second coating portion 120A to an external environment. The hydrophobic region may vary depending on the area of the surface of the cocoon particle 110A covered by the first coating portion 130A and the second coating portion 120A.

In one embodiment, the Janus abrasive particle 100A may include a hydrophobic region. The hydrophobic region may allow the abrasive particles to be arranged in a specific direction, that is, anisotropically, when a polishing target is polished using a polishing slurry composition. For example, when Janus abrasive particles 100A including a hydrophobic region are provided on a device surface having hydrophobicity, such as a hydrophobic polishing pad surface, an attractive force may act between the hydrophobic region of the Janus abrasive particles 100A and the surface of the hydrophobic polishing pad. Due to this attractive force, the particles may be adsorbed in a specific direction to control their arrangement.

The second region A2 of the surface of the Janus abrasive particle 100A has hydrophobicity, so that the second region A2 may be easily adsorbed onto the hydrophobic polishing pad (not shown) of the chemical mechanical polishing apparatus. Specifically, when the Janus abrasive particles 100A in the polishing slurry composition are adsorbed onto the polishing pad, they may be arranged in a predetermined direction based on their characteristics.

For example, when the hydrophobic polishing pad (not shown) is formed of a hydrophobic material, the Janus abrasive particles 100A may be adsorbed onto the surface of the polishing pad such that the second coating portion 120A is in contact with the pad. The hydrophobic polishing pad (not shown) may be formed of hydrophobic polyurethane with a composition ratio of hydrophilic functional groups (—NH₃, —COOH, —OH, etc.) of about 30% or less, for example, 20% or 10% or less, of the total.

Additionally, the hydrophobic polishing pad (not shown) may be formed of a hydrophobic material such as acrylic, epoxy, polyethylene, polystyrene, polyvinyl chloride, polytetrafluoroethylene, polydimethylsiloxane, or polyester, in addition to polyurethane. Even when the hydrophobic polishing pad (not shown) is formed of a hydrophobic material other than polyurethane, the effect of arranging the abrasive particles in a predetermined direction as described above may be obtained.

Hereinafter, a method of manufacturing a cocoon-type Janus abrasive particle according to an embodiment of the present disclosure will be described.

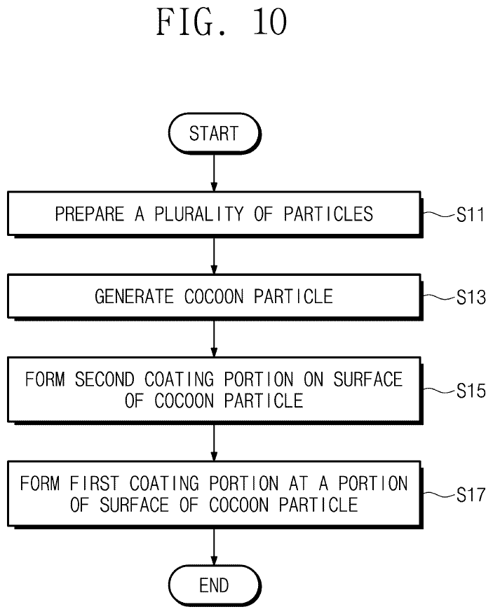

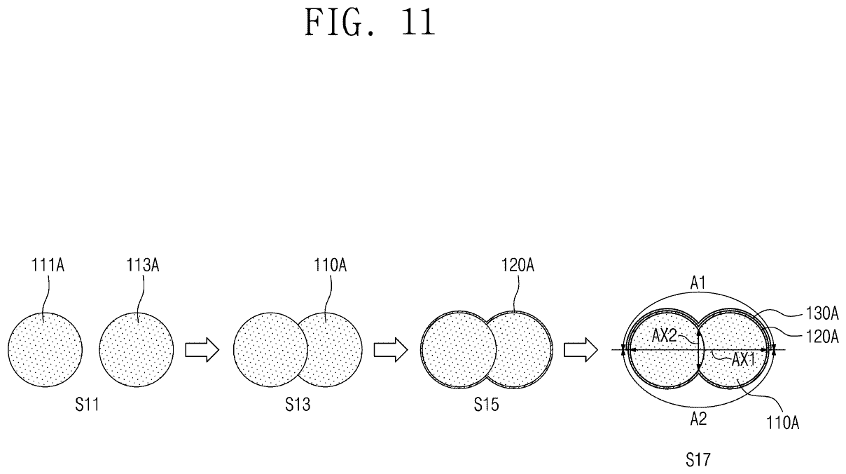

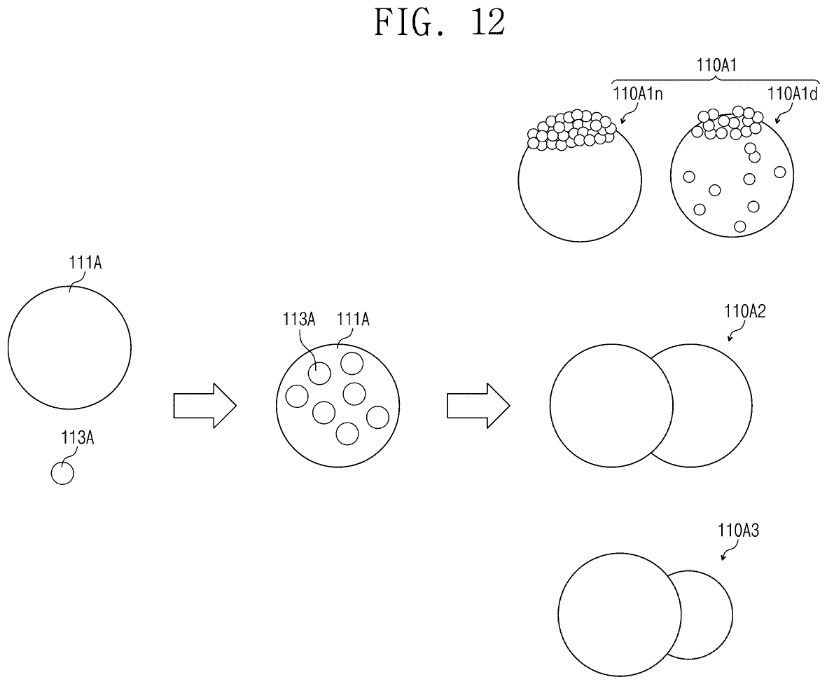

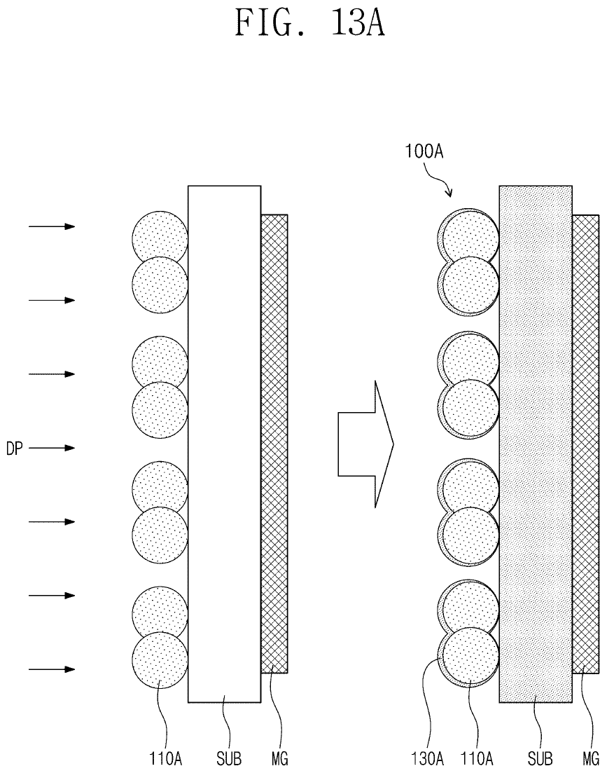

FIG. 10 is a flowchart illustrating a method of manufacturing a Janus abrasive particle according to an embodiment of the present disclosure, and FIG. 11 sequentially illustrates cross-sectional views of a Janus abrasive particle manufactured by the method according to an embodiment of the present disclosure.

Referring to FIGS. 10 and 11, a method of manufacturing a Janus abrasive particle 100A according to an embodiment of the present disclosure may include preparing a plurality of particles S11, generating a cocoon particle S13, forming a second coating portion on a surface of the cocoon particle S15, and forming a first coating portion at a portion of the surface of the cocoon particle S17.

In operation S11, multiple particles may be prepared. The multiple particles may include first particles 111A and second particles 113A. The number of the first particles 111A and second particles 113A is not limited, and they may be formed of the same or different materials.

In operation S13, the cocoon particle 110A may be formed through the polymerization of the first particles 111A and second particles 113A. As described above, the number of particles forming the cocoon particle 110A may vary depending on the number of particles subjected to polymerization, and the particles may be formed of the same or different materials. The cocoon particle 110A may be formed using the method illustrated in FIG. 12.

In operation S15, the second coating portion 120A may be formed on the surface of the cocoon particle 110A. The second coating portion 120A may include a hydrophilic or hydrophobic material. The formation of the second coating portion 120A may be performed through chemical vapor deposition, physical vapor deposition, coating, and/or solution-phase reaction. In some embodiments, operation S15 is not essential for manufacturing the Janus abrasive particle 100A and may be omitted.

In operation S17, the first coating portion 130A may be formed on the first region A1 of the surface of the cocoon particle 110A. Here, the first region A1 may be a region provided in an elongated direction along the major axis AX1 of the cocoon particle 110A, while the second region A2 may constitute the remaining portion of the surface except for the first region A1. Furthermore, the first region A1 and the second region A2 may be sequentially arranged along the minor axis AX2 and may not overlap each other.

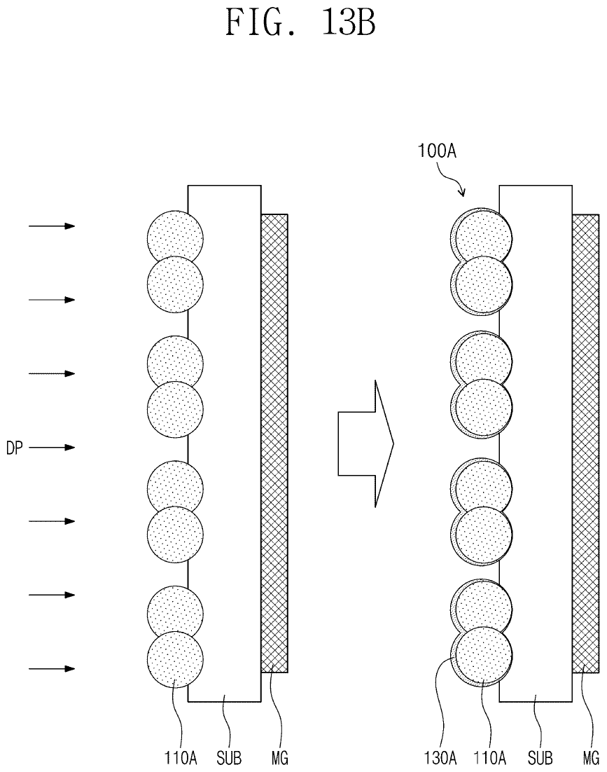

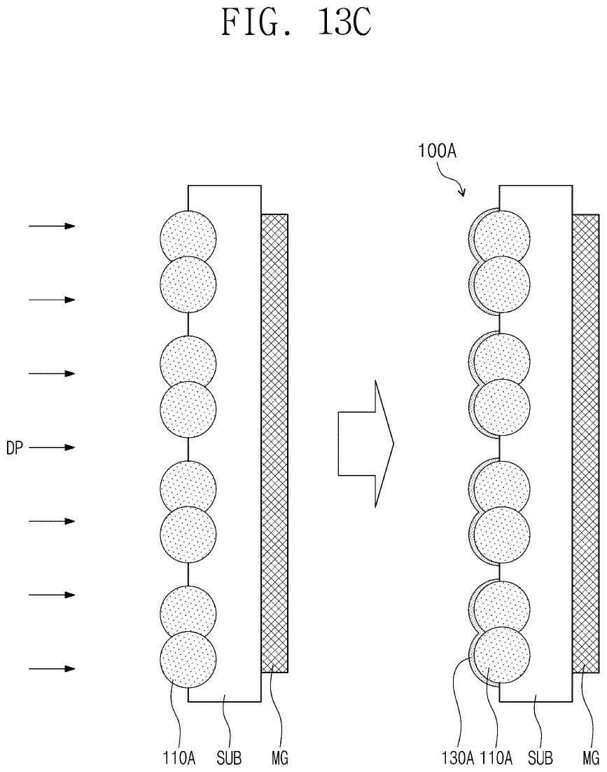

Additionally, the first coating portion 130A may cover 50% or more but less than 100% of the surface of the cocoon particle 110A. Accordingly, a portion of the surface of the cocoon particle 110A where the first coating portion 130A is not formed may expose the second coating portion 120A and/or part of the cocoon particle 110A itself to the external environment. For example, due to the formation of the first coating portion 130A, the second coating portion 120A may be exposed on the second region A2 of the cocoon particle 110A, where the second coating portion 120A may exhibit hydrophilic or hydrophobic properties. The first coating portion 130A may be formed on the cocoon particles 110A while in contact with a substrate using chemical vapor deposition (CVD), physical vapor deposition, coating, and/or solution-phase reaction. Meanwhile, the first coating portion 130A may be formed using the method illustrated in FIGS. 13A to 13C.

Through the above-described process, the final cocoon-type Janus abrasive particle 100A may be obtained.

FIG. 12 is a sequential cross-sectional view illustrating the formation process of a cocoon particle in the method of manufacturing a Janus abrasive particle according to an embodiment of the present disclosure. A cocoon particle may be manufactured using various materials and methods. Hereinafter, an example of manufacturing a cocoon particle through polymerization will be described.

First, the prepared first particle 111A and/or the second particle 113A may be swollen using a functional monomer and a crosslinker. In the present disclosure, a functional monomer means a monomer that can be polymerized by application of light or heat. The particles 111A and 113A may be stored, e.g., in a bottle, at room temperature for about 30 minutes. The particles 111A and 113A may then be mixed with a functional monomer and a crosslinker in an oil phase and subsequently dispersed in an aqueous sodium dodecyl sulfate (SDS) solution. Here, glycidyl methacrylate (GMA) may be used as the functional monomer, and dipentaerythritol penta-/hexa-acrylate (DPEPA) may be used as the crosslinker. Through this process, the particles 111A and 113A may undergo swelling.

Next, a cocoon particle 110A may be generated through an ultraviolet polymerization reaction of the swollen first particle 111A and/or the swollen second particle 113A. The ultraviolet polymerization reaction may be performed by exposing the first particle 111A and/or the second particle 113A to ultraviolet light for about one hour or more.

By controlling the conditions of the swelling process and the ultraviolet polymerization reaction, cocoon particles 110A of the desired shape, e.g., 110A1, 110A2, 110A3, may be generated. For example, the shape of the generated cocoon particles 110A may vary depending on the molar ratio of the functional monomer and the crosslinker, the amount of particles, the ultraviolet exposure time, and the composition of the aqueous solution. Additionally, under specific conditions, the generated cocoon particles 110A may have a uniform shape. In one embodiment of the present disclosure, half-raspberry-like cocoon particles 110A1, dumbbell-like cocoon particles 110A2, or egg-like cocoon particles 110A3 may be uniformly generated.

Finally, the cocoon particles 110A1, 110A2, and 110A3 generated through the ultraviolet polymerization reaction may be acidified in an acidic solution (e.g., a 0.1 mol/L sulfuric acid solution). The acidified cocoon particles 110A1, 110A2, and 110A3 may be dried at room temperature and then washed three to five times using a mixture of deionized water and ethanol. Through this process, the final cocoon particles 110A1, 110A2, and 110A3 may be obtained.

FIGS. 13A to 13C are cross-sectional views illustrating an example of forming the first coating portion with different contact areas between cocoon particles and a substrate.

Referring to FIGS. 13A to 13C, the contact area between the cocoon particles 110A and the substrate SUB may increase in the order of FIG. 13A, FIG. 13B, and FIG. 13C.

Magnetic force may be used to arrange the cocoon particles 110A on the substrate SUB. As described above, a third coating portion 140A containing a magnetic material may be provided on the remaining region of the cocoon particle 110A, excluding the area where the first coating portion 130A is provided. Alternatively, the magnetic material may be included in the cocoon particles 110A themselves. A magnet MG may be positioned on the opposite side of the substrate SUB, where the cocoon particles 110A are placed. As a result, the cocoon particles 110A may adhere to the surface of the substrate SUB due to the magnetic force of the magnet MG. The magnet MG may be an electromagnet or a permanent magnet.

The difference in the contact area of the cocoon particles 110A may depend on the flexibility of the substrate SUB and/or the strength of the magnetic force. If the substrate SUB is flexible, the magnetic force acting on the cocoon particles 110A may create a force that moves them toward the magnet MG. Accordingly, depressions may form on the surface of the substrate SUB due to the cocoon particles 110A, increasing the contact area with the cocoon particles 110A. If the substrate SUB is rigid, depressions are unlikely to form even under strong magnetic force, resulting in a relatively smaller contact area between the cocoon particles 110A and the surface of the substrate SUB. Additionally, if the magnet MG has strong magnetic force, the contact area between the cocoon particles 110A and the substrate SUB may increase even with low flexibility.

Rigid substrates and flexible substrates may be provided in various forms. For example, the rigid substrate may be a glass substrate, a metal substrate, or a silicon substrate. The flexible substrate may be a polymer substrate made of a flexible gel or similar material.

Referring to FIG. 13A, when the substrate SUB is rigid or has weak magnetic force, the cocoon particles 110A may contact the substrate SUB, but the contact area may not be relatively large.

Referring to FIG. 13B, when the substrate SUB has moderate flexibility and/or magnetic force, the contact area between the cocoon particles 110A and the surface of the substrate SUB may be relatively larger compared to FIG. 13A.

Referring to FIG. 13C, when the substrate SUB has significant flexibility or, even with low flexibility, strong magnetic force, the contact area between the cocoon particles 110A and the surface of the substrate SUB may be further increased compared to FIGS. 13A and 13B.

As described above, the first coating portion 130A may be formed on the surface of the cocoon particles 110A using chemical vapor deposition, physical vapor deposition, coating, and/or solution-phase reaction in a perpendicular direction DP to the surface of the substrate SUB while the cocoon particles 110A are arranged on the substrate SUB. Through this method, the final Janus abrasive particle 100A according to an embodiment of the present disclosure may be manufactured.

Thus, according to an embodiment of the present disclosure, Janus abrasive particles may be used in a polishing slurry composition for chemical mechanical polishing (CMP) to reduce scratch defects. Furthermore, a polishing etch rate may be increased to improve the polishing efficiency for a target surface.

While embodiments of the present disclosure have been described and illustrated above, it will be apparent to those skilled in the art that modifications and variations can be made without departing from the scope of the present invention as defined by the appended claims.

Meanwhile, a single fine-particle type Janus abrasive particle 100B will be described below. For convenience of explanation, the following description will primarily focus on the differences from the previously described embodiments.

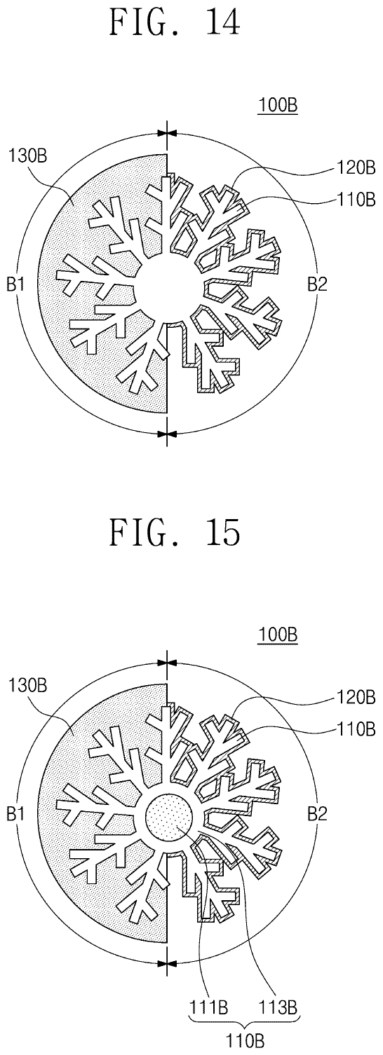

FIG. 14 is a cross-sectional view illustrating a Janus abrasive particle according to an embodiment of the present disclosure. FIG. 15 is another cross-sectional view illustrating a Janus abrasive particle according to an embodiment of the present disclosure.

Referring to FIGS. 14 and 15, the Janus abrasive particle 100B according to an embodiment of the present disclosure may include a core particle 110B, a first coating portion 130B provided on a part of the core particle 110B, and a second coating portion 120B.

The core particle 110B forms the main body of the Janus abrasive particle 100B and may be provided at the center of the Janus abrasive particle 100B. The core particle 110B may have a dendritic structure. A dendritic structure refers to a particle configuration in which multiple branches extend outward in all directions from a central spherical core. In other words, it represents a structure where multiple branches freely extend in all directions from the center of a spherical shape. Consequently, compared to a spherical particle, a particle with a dendritic structure may have an increased surface area available for friction and/or reaction with other particles.

In one embodiment, the core particle 110B may include a pyroelectric material. For example, the core particle 110B may include hydroxyapatite (Ca₁₀(PO₄)₆(OH)₂), barium titanate (BaTiO₃), bismuth ferrite (BiFeO₃), potassium niobate (KNbO₃), dibutylammonium perrhenate ((C₆H₁₄N₂) ReO₄), lead zirconate (PbZrO₃), lead titanate (PbTiO₃), triglycine sulfate (CH₆O₄S), lithium tantalate (LiTaO₃), lithium niobate (LiNbO₃), polyvinylidene fluoride (PVDF; (C₂H₂F₂)n), polyvinylidene fluoride-trifluoroethylene copolymer (PVDF-TrFE; (C₂H₂F₂)n-(C₂H₂F₄O₂) m), erbium-doped PVDF (Er-doped PVDF), PVDF-methylammonium lead iodide (PVDF-MAPbI₃; (C₂H₂F₂)n-(CH₃NH₃PbI₃)), fluorapatite-gelatin mixture ((Ca₅(PO₄)₃F+gelatin), polyvinyl chloride (PVC; (C₂H₃Cl)n), polyacrylonitrile (PAN; (C₃H₃N)n), hafnium oxide (HfO₂), or combinations thereof.

Here, the values of ‘n’ and ‘m’ for the materials listed in the descriptions, such as polyvinylidene fluoride (PVDF), polyvinylidene fluoride-trifluoroethylene copolymer (PVDF-TrFE), and polyvinylidene fluoride-methylammonium lead iodide (PVDF-MAPbI₃), may encompass the entire range of values typically used in industry. These values may be commonly within the molecular weight and polymerization degree ranges that are widely utilized for the corresponding materials in various applications. For example, n and m may range from several tens to several thousand, depending on the specific application, with n typically ranging from 50 to 5,000 and m corresponding to similar molecular weight ranges. These ranges may be considered to be within the standard scope of the materials as typically used in industry.

In one embodiment, the core particle 110B may include silica (SiO₂), zirconia (ZrO₂), titania (TiO₂), ceria (CeO₂), alumina (Al₂O₃), surface-modified inorganic oxide particles, or combinations thereof. The core particle 110B may include an inorganic oxide as a main polishing material. The inorganic oxide may include, for example, silica (SiO₂), zirconia (ZrO₂), titania (TiO₂), ceria (CeO₂), alumina (Al₂O₃), surface-modified inorganic oxide particles, or combinations thereof. However, the material of the core particle 110B is not limited thereto and may include metal oxide particles such as iron (Fe), aluminum (Al), lanthanum (La), manganese (Mn), zinc (Zn), calcium (Ca), magnesium (Mg), strontium (Sr), cobalt (Co), ruthenium (Ru), osmium (Os), rhodium (Rh), iridium (Ir), nickel (Ni), palladium (Pd), platinum (Pt), copper (Cu), silver (Ag), or gold (Au).

In one embodiment, the core particle 110B may primarily include a magnetic material. Alternatively, when the core particle 110B mainly comprises a non-magnetic material, it may additionally include a magnetic material. For example, in addition to non-magnetic materials, the core particle 110B may further include magnetic materials such as Fe₃O₄, Fe₂O₃, Co₂Fe₃O₄, or combinations thereof. By having magnetic properties, the core particle 110B enables the Janus abrasive particle 100B to be easily manufactured using magnetism. Additionally, if the core particle 110B exhibits magnetism, the Janus abrasive particle 100B may be easily controlled even after manufacturing, allowing for directional alignment or other adjustments using magnetic forces.

The core particle 110B may consist of a single, integrally formed component; however, it is not limited thereto and may include multiple structural components. In one embodiment, the core particle 110B may be provided in a core-shell structure consisting of a core 111B and a shell 113B surrounding the core 111B.

When the core particle 110B has a core 111B and a shell 113B structure, the core 111B may include a metal or metal oxide, while the shell 113B may include a metal oxide and/or an inorganic oxide. The metal in the metal or metal oxide forming the core 111B may be Fe, Zr, Al, La, Mn, Zn, Ca, Mg, Sr, Co, Ce, Ru, Os, Rh, Ir, Ni, Pd, Pt, Cu, Ag, or Au. The shell 113B may include various metal oxides and/or inorganic oxides. For example, the shell 113B may include silica (SiO₂), zirconia (ZrO₂), titania (TiO₂), ceria (CeO₂), alumina (Al₂O₃), surface-modified inorganic oxide particles, or combinations thereof.

In one embodiment, at least one of the core 111B and the shell 113B may be a magnetic material. The core 111B may include, for example, Fe₃O₄, Fe₂O₃, or Co₂Fe₃O₄. If the core 111B includes a magnetic material, the shell 113B may include either a magnetic material or a non-magnetic material. Conversely, if the core 111B does not include a magnetic material, the shell 113B may include a magnetic material. As a result, the core particle 110B as a whole may exhibit magnetic properties.

In one embodiment, the core 111B may include a magnetic material, while the shell 113B may include a pyroelectric material with a dendritic structure.

The surface of the core particle 110B may be provided with materials having different chemical/physical properties. For example, different materials may be coated onto different regions of the core particle 110B to impart hydrophilicity and hydrophobicity.

In one embodiment of the present disclosure, the surface of the Janus abrasive particle 100B may include two regions with different chemical/physical properties. These two regions may include a first region B1, which exhibits hydrophilicity, and a second region B2, which exhibits hydrophobicity. That is, the first region B1 may be a region where a hydrophilic material is provided on the core particle 110B, while the second region B2 may be a region where a hydrophobic material is provided. In one embodiment, the first region B1 and the second region B2 do not overlap each other. For example, the first region B1 may correspond to one hemisphere of the core particle 110B, while the second region B2 may correspond to the opposite hemisphere.

The coated areas with different materials may be referred to as coating portions, which may include a first coating portion 130B and a second coating portion 120B. The first coating portion 130B may be coated on at least a part of the core particle 110B, while the second coating portion 120B may be coated on another part of the core particle 110B that is not covered by the first coating portion 130B. For example, the first coating portion 130B may be provided on the first region B1, while the second coating portion 120B may be provided on the second region B2.

In one embodiment of the present disclosure, the first coating portion 130B may be a fan-shaped coated portion on the first region B1, while the second coating portion 120B may be a conformally coated portion on the second region B2 of the core particle 110B.

One of the first coating portion 130B and the second coating portion 120B may be intended to control the behavior of the Janus abrasive particle 100B, such as by aligning it in a specific direction, while the other coating portion may be designed to efficiently polish the target surface. For example, the first coating portion 130B may serve to efficiently polish the target surface, while the second coating portion 120B may be used to control the behavior of the Janus abrasive particle 100B by aligning it in a specific direction.

The first coating portion 130B and the second coating portion 120B may include materials with different chemical/physical properties, such as hydrophobic or hydrophilic materials. For example, the second coating portion 120B may include a hydrophobic polymer. In one embodiment, hydrophobic polymers may include acrylic, epoxy, polyethylene, polystyrene, polyvinyl chloride, polytetrafluoroethylene, polydimethylsiloxane, polyester, polyurethane, and others. However, hydrophobic polymers are not limited to these examples, and various polymers exhibiting hydrophobicity may be used.

In one embodiment, the second coating portion 120B may include a surface-modified inorganic oxide. The surface-modified inorganic oxide may include, for example, an ionic polymer having a specific charge. The surface-modified inorganic oxide may be provided as a composite material including either a cationic polymer, an anionic polymer, or a nonionic polymer. That is, the second coating portion 120B may include any one of a cationic polymer, an anionic polymer, or a nonionic polymer.

The first coating portion 130B may include various materials, such as metal oxides, surface-modified metal oxides, inorganic oxides, or inorganic oxide particles, to facilitate the efficient polishing of the target surface. The first coating portion 130B may include a main polishing material. In other words, the first coating portion 130B may include abrasive particles. For example, the first coating portion 130B may include silica (SiO₂), zirconia (ZrO₂), titania (TiO₂), ceria (CeO₂), alumina (Al₂O₃), surface-modified inorganic oxide particles, or combinations thereof.

In one embodiment, the materials used for the first coating portion 130B may be different from those of the core particle 110B. For example, a pyroelectric material may be used as the core particle 110B, while ceria may be used for the first coating portion 130B. When ceria is used for the first coating portion 130B, it may serve to efficiently polish a specific target surface.

In one embodiment of the present disclosure, the surface-modified inorganic oxide may be prepared through a coupling reaction on the surface of the inorganic oxide using a polymer graft. For example, it may be prepared by coupling a hydroxyl group of the inorganic oxide with a prepolymer having a terminal group reactive with the hydroxyl group. Examples of terminal groups reactive with hydroxyl groups include isocyanate groups, trialkoxysilyl groups, and chlorosilyl groups. However, the method of preparing the surface-modified inorganic oxide is not limited thereto, and various other methods, such as radical polymerization reactions on the surface, may also be used.

Materials that may be used for the surface-modified inorganic oxide include cationic monomers and/or polymers, anionic monomers and/or polymers, or nonionic monomers and/or polymers.

Meanwhile, the materials used for the first coating portion 130B are not limited thereto and may partially or entirely match the components forming the core particle 110B.

In one embodiment of the present disclosure, the first coating portion 130B may be provided on the core particle 110B with a greater thickness than the second coating portion 120B. However, the thickness of the first coating portion 130B and the second coating portion 120B is not limited to this configuration. For example, the first coating portion 130B and the second coating portion 120B may be provided on the core particle 110B with substantially the same thickness. Alternatively, the first coating portion 130B may be provided with a smaller thickness than the second coating portion 120B. The thickness of the first coating portion 130B and the second coating portion 120B may vary depending on the polishing environment of the abrasive particle. For example, the thickness of the first coating portion 130B and the second coating portion 120B may vary depending on the target to be polished.

In one embodiment of the present disclosure, the Janus abrasive particle 100B may be modified into various forms within the scope of the present disclosure.

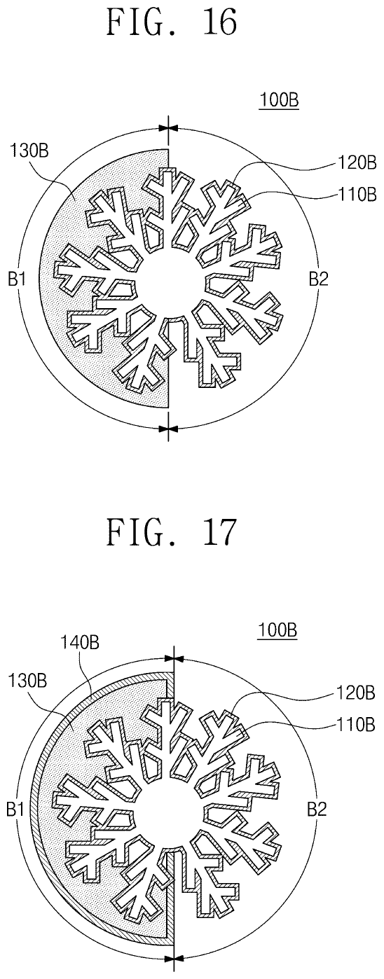

FIG. 16 is a cross-sectional view illustrating a Janus abrasive particle according to an embodiment of the present disclosure. FIG. 17 is another cross-sectional view illustrating a Janus abrasive particle according to an embodiment of the present disclosure.

Referring to FIGS. 16 and 17, the second coating portion 120B may be provided over the entire surface of the core particle 110B. That is, the second coating portion 120B may completely encapsulate the core particle 110B. At this time, the first coating portion 130B is provided on a part of the surface of the second coating portion 120B, and the surface of the second coating portion 120B that is not overlapped by the first coating portion 130B is exposed externally.

More specifically, the second coating portion 120B may be provided over both the first region B1 and the second region B2, while the first coating portion 130B may be provided on the first region B1. For example, the second coating portion 120B may be conformally provided over the entire surface of the core particle 110B, and the first coating portion 130B may be provided in a fan-shaped cross-section over the part of the core particle 110B corresponding to the first region B1. At this time, the thickness of the second coating portion 120B may be smaller than that of the first coating portion 130B. Accordingly, the first coating portion 130B may partially overlap with the surface of the second coating portion 120B.

In one embodiment, the second coating portion 120B may include a hydrophobic material, while the first coating portion 130B may include a hydrophilic material. As a result, the surface of the Janus abrasive particle 100B where the first coating portion 130B is formed may exhibit hydrophilicity, while the surface of the Janus abrasive particle 100B where the second coating portion 120B is exposed may exhibit hydrophobicity. That is, the first region B1 may be hydrophilic, while the second region B2 may be hydrophobic.

In one embodiment, the Janus abrasive particle 100B may further include a third coating portion 140B provided over the first coating portion 130B. As shown in FIG. 17, the third coating portion 140B may be provided on the first region B1. For example, the third coating portion 140B may be provided on the exposed surface of the first coating portion 130B.

The third coating portion 140B may be formed on the first coating portion 130B, which is exposed in the first region B1. The third coating portion 140B may serve as an additional protective layer that enhances the chemical/physical properties of the Janus abrasive particle 100B.

The third coating portion 140B may include a material that differs from both the first coating portion 130B and the second coating portion 120B. For example, the third coating portion 140B may include a material with a specific charge. The third coating portion 140B may include, for example, a cationic polymer or an anionic polymer. If the polishing target has a specific charge, the third coating portion 140B may be formed from a polymer with an opposite charge to that of the target. By having an opposite charge to the polishing target, the polymer of the third coating portion 140B may be more easily adsorbed onto the target surface during the polishing process. For example, if the polishing target has an anionic charge, the third coating portion 140B may include a cationic polymer. In some embodiments, advantageously, when the third coating portion 140B is formed from a polymer with a charge opposite to that of the polishing target, the adsorption efficiency of the Janus abrasive particle 100B onto the polishing target may increase. As a result, the polishing efficiency may be enhanced.

In one embodiment, the formation of the third coating portion 140B is optional and may be omitted.

In one embodiment of the present disclosure, the first region B1 may be formed differently from the previously described embodiments.

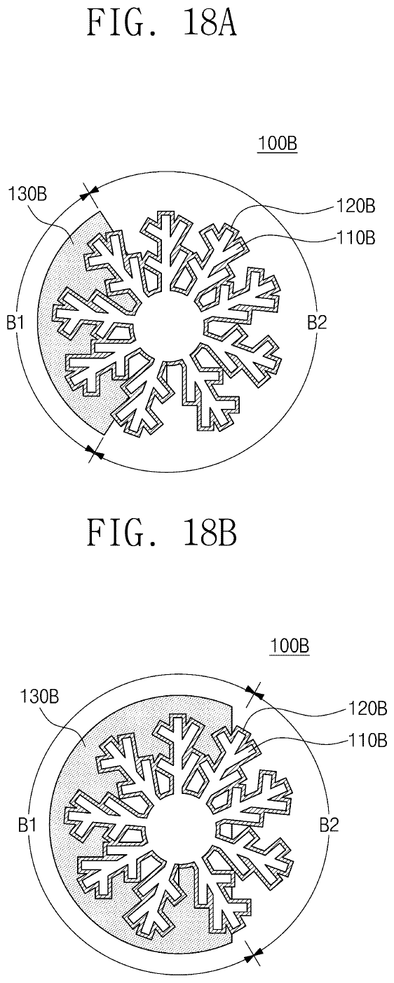

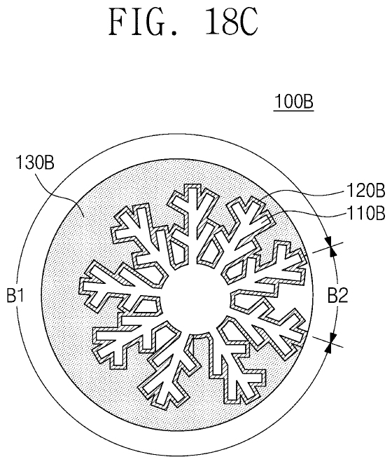

FIGS. 18A to 18C are cross-sectional views illustrating Janus abrasive particles according to an embodiment of the present disclosure.

Referring to FIGS. 18A to 18C, the areas of the exposed first region B1 and second region B2 may differ. For example, as shown in FIG. 18A, the exposed area of the second region B2 may be larger than that of the first region B1. In this case, the first region B1 may be formed on only a part of the surface of the core particle 110B, for example, on less than 50%, for example less than 40% or less than 30%, of the total surface area.

As shown in FIG. 18B, the exposed area of the second region B2 may be smaller than that of the first region B1. In this case, the first region B1 may be formed on a portion of the surface of the core particle 110B, for example, covering 50% or more but less than 80% of the total surface area, for example 60% or 70% of the total surface area.

As shown in FIG. 18C, the exposed area of the second region B2 may be very small, and the first coating portion 130B may be provided over most of the surface of the core particle 110B. In this case, the first region B1 may be formed on the majority of the surface of the core particle 110B, for example, covering 80% or more but less than 100% of the total surface area, for example, 85% or 95% of the total surface area.

Regardless of whether the area distribution of the first region B1 and the second region B2 corresponds to the cases illustrated in FIGS. 18A to 18C, at least a portion of the second region B2 may remain exposed externally. This exposure may facilitate adsorption onto a polishing pad.

For example, if the second region B2 exhibits hydrophobicity, the Janus abrasive particle 100B may be easily adsorbed onto a hydrophobic polishing pad during the polishing process. Conversely, if the second region B2 exhibits hydrophilicity, the Janus abrasive particle 100B may be easily adsorbed onto a hydrophilic polishing pad during the polishing process.

Hereinafter, a manufacturing method of a single fine-particle type Janus abrasive particle according to an embodiment of the present disclosure will be described.

A Janus abrasive particle 100B according to an embodiment of the present disclosure may be manufactured by forming a first coating portion 130B in the first region B1 and a second coating portion 120B in the second region B2. Here, the step of forming the second coating portion 120B in the second region B2 of the core particle 110B may be performed either before or after forming the first coating portion 130B.

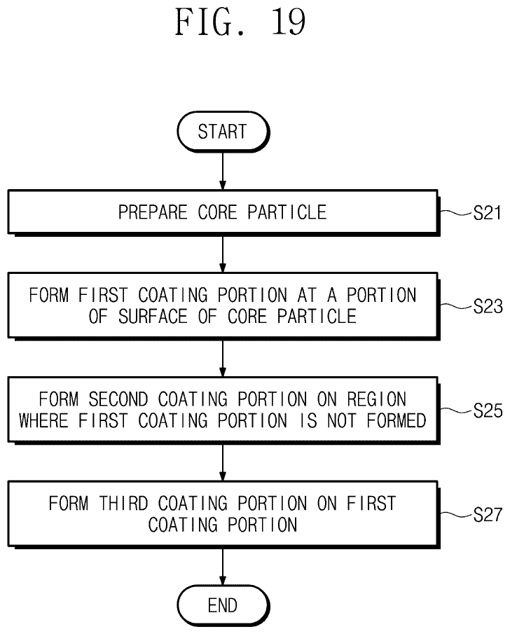

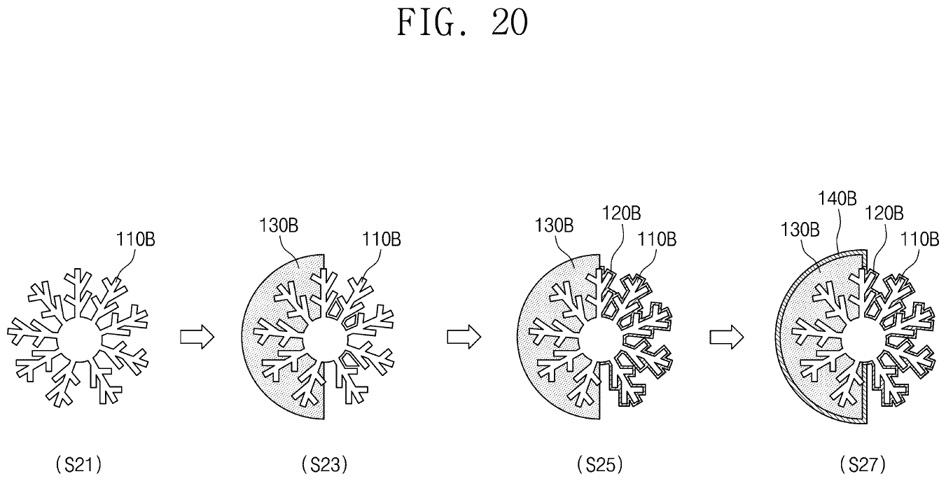

FIG. 19 is a flowchart illustrating a manufacturing method of a Janus abrasive particle according to an embodiment of the present disclosure, and FIG. 20 sequentially illustrates cross-sectional views of the manufacturing process of a Janus abrasive particle according to an embodiment of the present disclosure. Specifically, FIGS. 19 and 20 illustrate the manufacturing method of the Janus abrasive particles 100B shown in FIGS. 14 and 15.

Referring to FIGS. 19 and 20, the manufacturing method of the Janus abrasive particle 100B according to an embodiment of the present disclosure may include preparing a core particle S21, forming a first coating portion at a portion of a surface of the core particle S23, forming a second coating portion on a region where the first coating portion is not formed S25, and forming a third coating portion on the first coating portion S27.

In operation S21, the core particle 110B may first be prepared. The core particle 110B may be provided as a single-component particle, or it may be structured as a core-shell configuration such as a core 111B surrounded by a shell 113B.

In operation S23, the first coating portion 130B may be formed on a part of the surface of the core particle 110B. At this time, the first coating portion 130B may cover only a portion of the surface of the core particle 110B rather than the entire surface. The first coating portion 130B may, for example, be formed from a hydrophilic material.

The first coating portion 130B may be formed using chemical vapor deposition, physical vapor deposition, coating, and/or solution-phase reactions while the core particles 110B are in contact with a substrate SUB.

In one embodiment, the principle of forming the first coating portion 130B on a single fine-particle type Janus abrasive particle 100B may be substantially identical and/or similar to the principle of forming the first coating portion 130A on the cocoon-type Janus abrasive particle 100A (see FIGS. 13A to 13C).

In operation S25, the second coating portion 120B may be formed on the remaining part of the surface of the core particle 110B that is not covered by the first coating portion 130B. That is, the second coating portion 120B may be formed on the remaining regions of the core particle 110B that do not include the first coating portion 130B. The second coating portion 120B may, for example, be formed conformally over the remaining area.

The second coating portion 120B may, for example, be formed from a hydrophobic material. The second coating portion 120B may cover the regions of the core particle 110B that are not overlapped by the first coating portion 130B. As a result, the portion of the surface where the first coating portion 130B is formed may exhibit hydrophilicity, while the portion of the surface where the second coating portion 120B is formed may exhibit hydrophobicity. The second coating portion 120B may be formed using chemical vapor deposition, physical vapor deposition, coating, solution-phase reactions, and/or surface modification methods.

Through the formation of the first coating portion 130B and the second coating portion 120B, the first region B1 and the second region B2 of the Janus abrasive particle 100B are defined.

In operation S27, a third coating portion 140B may be conformally formed on the exposed surface of the first coating portion 130B. The third coating portion 140B is intended to facilitate directional alignment of the Janus abrasive particles 100B when placed on the polishing pad of a polishing apparatus. The third coating portion 140B may have an opposite charge to that of the second coating portion 120B.

The third coating portion 140B may, for example, include a hydrophilic material. The third coating portion 140B may be formed using chemical vapor deposition, physical vapor deposition, coating, and/or solution-phase reactions.

In one embodiment, operation S27 may be optional and can be omitted.

Through the above-described process, the Janus abrasive particle 100B according to an embodiment of the present disclosure can be successfully manufactured.

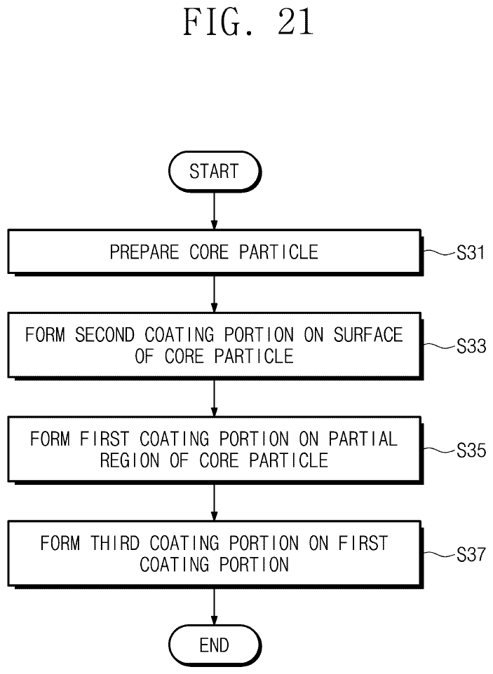

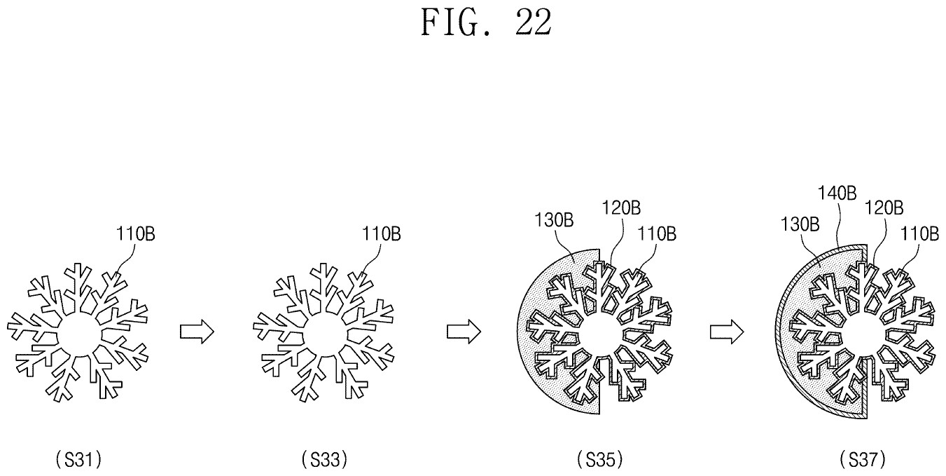

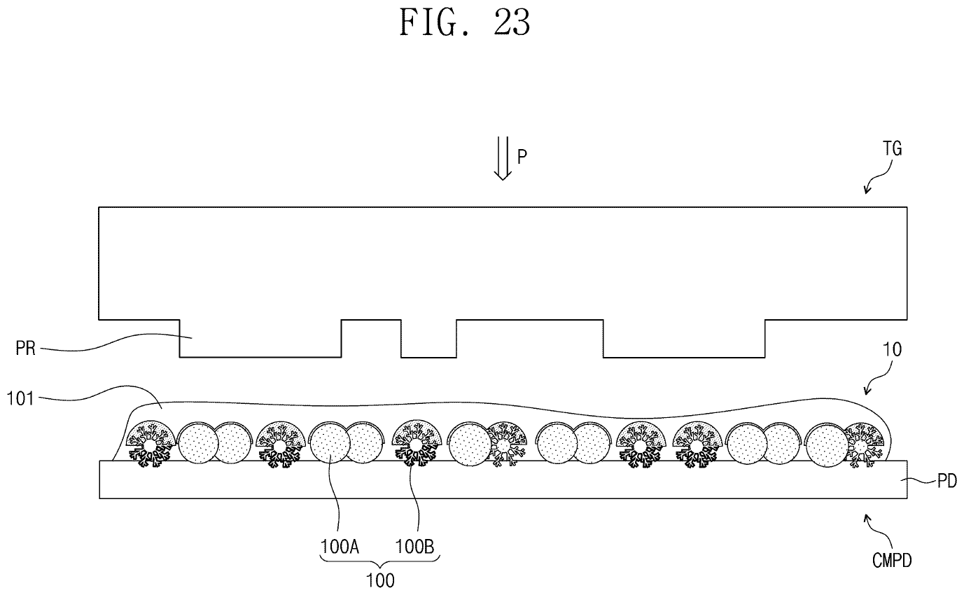

FIG. 21 is a flowchart illustrating a manufacturing method of a Janus abrasive particle according to an embodiment of the present disclosure, and FIG. 22 sequentially illustrates cross-sectional views of a manufacturing method of a Janus abrasive particle according to an embodiment of the present disclosure. Specifically, FIGS. 21 and 22 illustrate the manufacturing method of the Janus abrasive particles 100B shown in FIGS. 16 and 17. Hereinafter, for convenience of explanation, the description will primarily focus on the differences from the previously described manufacturing method of the Janus abrasive particle 100B.

Referring to FIGS. 21 and 22, the manufacturing method of the Janus abrasive particle 100B according to an embodiment of the present disclosure may include preparing a core particle S31, forming a second coating portion on a surface of the core particle S33, forming a first coating portion on a partial region of the core particle S35, and forming a third coating portion on the first coating portion S37.

In operation S31, as in the core particle preparation step S21 of FIG. 18, the core particle 110B may be prepared.

In operation S33, the second coating portion 120B may be conformally formed over the entire surface of the core particle 110B.

In operation S35, the first coating portion 130B may be formed on a part of the exposed surface of the second coating portion 120B. Through the formation of the first coating portion 130B, the first region B1 and the second region B2, which is the remaining area excluding the first region B1, of the Janus abrasive particle 100B may be defined.

In operation S37, the third coating portion 140B may be conformally formed on the exposed surface of the first coating portion 130B. The formation of the third coating portion 140B is optional, and operation S37 may be omitted.

Through the above-described process, the Janus abrasive particle 100B according to an embodiment of the present disclosure can be manufactured.

The cocoon-type Janus abrasive particles 100A and/or the single fine-particle type Janus abrasive particles 100B according to an embodiment of the present disclosure may be included in a chemical mechanical polishing slurry composition. Additionally, the polishing slurry composition may be provided to a chemical mechanical polishing apparatus. Hereinafter, the polishing slurry composition will be described.

The polishing slurry composition according to an embodiment of the present disclosure may include Janus abrasive particles 100A and 100B having different chemical and/or physical properties, and a solvent in which the Janus abrasive particles are dissolved and/or dispersed.

In one embodiment of the present disclosure, the Janus abrasive particles may be included in an amount ranging from 0.01 wt % to 10 wt % of the total weight of the polishing slurry composition. For example, the Janus abrasive particles may be included in an amount of 0.01 wt % to 10 wt %, 0.01 wt % to 5 wt %, 0.01 wt % to 3 wt %, 0.01 wt % to 1 wt %, 0.01 wt % to 0.5 wt %, 0.01 wt % to 0.3 wt %, or 0.01 wt % to 0.1 wt % of the total weight of the polishing slurry composition.

If the weight percentage of the Janus abrasive particles exceeds the above range, the likelihood of aggregation of the Janus abrasive particles within the polishing slurry composition may increase. Excessive aggregation of the Janus abrasive particles may lead to defects such as scratches on the polishing target. Additionally, the likelihood of Janus abrasive particles remaining on the surface of the polished target after polishing may increase, potentially acting as foreign matter on the surface.

Conversely, if the weight percentage of the Janus abrasive particles is below the above range, the polishing rate of the target surface may decrease, resulting in reduced polishing efficiency.

The solvent used in the chemical mechanical polishing slurry composition may be any solvent suitable for use in CMP applications. In one embodiment of the present disclosure, the solvent may be deionized water or ultrapure water.

In one embodiment of the present disclosure, the solvent may include water (e.g., deionized water) as an aqueous carrier and may further include one or more water-miscible organic solvents. The organic solvents may include alcohols (e.g., propenyl alcohol, isopropyl alcohol, ethanol, 1-propanol, methanol, 1-hexanol); aldehydes (e.g., acetaldehyde); ketones (e.g., acetone, diacetone alcohol, methyl ethyl ketone); esters (e.g., ethyl formate, propyl formate, ethyl acetate, methyl acetate, methyl lactate, butyl lactate, ethyl lactate); ethers including sulfoxides (e.g., dimethyl sulfoxide (DMSO), tetrahydrofuran, dioxane, diglyme); amides (e.g., N,N-dimethylformamide, dimethylimidazolidinone, N-methylpyrrolidone); polyols and their derivatives (e.g., ethylene glycol, glycerol, diethylene glycol, diethylene glycol monomethyl ether); and/or nitrogen-containing organic compounds (e.g., acetonitrile, amylamine, isopropylamine, dimethylamine).

The weight of the solvent may correspond to the remaining weight of the polishing slurry composition excluding the weight of the Janus abrasive particles. If the polishing slurry composition includes additional additives, the weight of the solvent may correspond to the remaining weight excluding both the Janus abrasive particles and the additives.

The polishing slurry composition may be provided as a colloidal-type composition. In this case, the Janus abrasive particles may be colloidal particles. If the Janus abrasive particles are provided in a colloidal form, the zeta potential value of the Janus abrasive particles in a pH range of approximately 2 to 12 may be 1 mV to 100 mV, 1 mV to 80 mV, 5 mV to 60 mV, or 10 mV to 50 mV.

The size of the Janus abrasive particles may vary depending on the polishing target and the composition of the slurry, but they may be at the nanometer scale, for example, having a diameter ranging from a few nanometers to several hundred nanometers. For example, the size of the Janus abrasive particles may be 1 nm to 400 nm, 1 nm to 200 nm, or 1 nm to 100 nm.

In another example, the size of the Janus abrasive particles 100A may be 1 nm to 50 nm, 1 nm to 25 nm, 1 nm to 10 nm, or 1 nm to 5 nm.

If the size of the Janus abrasive particles exceeds the above range, the likelihood of aggregation increases, and they may also be more likely to remain adsorbed on the surface of the polished target. Conversely, if the size of the Janus abrasive particles is below the above range, the polishing rate may be excessively low, leading to reduced polishing efficiency.

In one embodiment of the present disclosure, the polishing slurry composition may include clusters formed by the aggregation of multiple Janus abrasive particles.

Here, a cluster refers to a structure where multiple Janus abrasive particles are physically and/or chemically bonded together, forming a single aggregated mass. That is, multiple Janus abrasive particles may bond and/or aggregate to form a cluster.

In one embodiment, the polishing slurry composition may include multiple clusters. Additionally, a pyroelectric material may be provided on the surface of each cluster. The pyroelectric material may be, for example, coated on the surface of each cluster.

In one embodiment of the present disclosure, the polishing slurry composition may include various additives in addition to the Janus abrasive particles and the solvent.

A pH adjuster may be included in the polishing slurry composition. The pH adjuster may be used to adjust the pH of the polishing slurry composition to a range of approximately 2 to 12, or any range therein.

The pH adjuster may control the final pH of the composition, the polishing rate, and the polishing selectivity. The pH adjuster may include one or more acidic or basic pH adjusters and buffers. A substance capable of adjusting the pH without adversely affecting the properties of the polishing slurry composition may be used as the pH adjuster.

In one embodiment of the present disclosure, the pH adjuster may be an acidic pH adjuster or a basic pH adjuster. For example, the pH adjuster may include one or more inorganic acids selected from the group consisting of sulfuric acid, hydrochloric acid, nitric acid, and phosphoric acid; one or more organic acids selected from the group consisting of acetic acid, citric acid, glutaric acid, glycolic acid, formic acid, lactic acid, malic acid, malonic acid, maleic acid, oxalic acid, phthalic acid, succinic acid, and tartaric acid; one or more amino acids selected from the group consisting of lysine, glycine, alanine, arginine, valine, leucine, isoleucine, methionine, cysteine, proline, histidine, phenylalanine, serine, threonine, tyrosine, aspartic acid, tryptophan, and aminobutyric acid; imidazole; alkyl amines; alcohol amines; quaternary ammonium hydroxides; ammonia; or combinations thereof.

In particular, the pH adjuster may be triethanolamine, tetramethylammonium hydroxide (TMAH or TMAOH), or tetraethylammonium hydroxide (TEAH or TEA-OH). Additionally, examples of the pH adjuster may include ammonium methyl propanol (AMP), tetramethylammonium hydroxide (TMAH), potassium hydroxide, sodium hydroxide, magnesium hydroxide, rubidium hydroxide, cesium hydroxide, sodium bicarbonate, sodium carbonate, triethanolamine, tromethamine, or niacinamide. In one embodiment of the present disclosure, the pH adjuster may be triethanolamine or aminobutyric acid.

The amount of the pH adjuster may range from about 0.0001 wt % to about 5 wt % of the total weight of the polishing slurry composition. For example, the pH adjuster may be included in an amount ranging from about 0.0005 wt % to about 1 wt %, about 0.0005 wt % to about 0.5 wt %, or about 0.001 wt % to about 0.1 wt % of the total weight of the polishing slurry composition.

A surfactant may be further included in the polishing slurry composition. The surfactant may be a cationic surfactant, an anionic surfactant, an anionic polymer electrolyte, a nonionic surfactant, an amphoteric surfactant, a fluorinated surfactant, and/or a mixture thereof. The surfactant may be selected from sodium dodecyl sulfate, sodium lauryl sulfate, ammonium dodecyl sulfate, alcohol ethoxylates, acetylene-based surfactants, or combinations thereof.

The amount of the surfactant may range from about 0.0001 wt % to about 10 wt % of the total weight of the polishing slurry composition, for example, about 0.001 wt % to about 2 wt % or about 0.001 wt % to about 0.1 wt %.

The surfactant may stabilize the polishing slurry composition. The content of the surfactant may vary depending on the surface properties of the Janus abrasive particles. If an insufficient amount of surfactant is used, the polishing slurry composition may not be stabilized. Conversely, if an excessive amount of surfactant is used, unintended foaming and/or flocculation may occur within the polishing slurry composition.

A dispersing additive may be included in the polishing slurry composition to stabilize the dispersion of the particles within the slurry. The dispersing additive may include organic acids and their salts, polymeric acids and their salts, water-soluble copolymers and their salts, copolymers containing at least two different types of acid functional groups such as carboxylic acid, sulfonic acid, or phosphonic acid within the same molecule, polyvinyl acid and its salts, polyethylene oxide, polypropylene oxide, and/or combinations thereof.

The polymeric acid may include polyacrylic acid, polymethacrylic acid, polystyrene sulfonic acid, and/or their salts. The number average molecular weight (Mn) of the polymer may range from about 1,000 to about 1,000,000, for example, about 2,000 to about 100,000, or about 10,000 to about 50,000.

The amount of the dispersing additive may range from about 0.001 wt % to about 1.0 wt % of the total weight of the polishing slurry composition, for example, about 0.005 wt % to about 0.5 wt % or about 0.01 wt % to about 0.25 wt %.

An oxidizing agent and an oxidation catalyst may be included in the polishing slurry composition depending on the target material to be polished. For example, if the target material is a metal, the polishing slurry composition may further include an oxidizing agent, an oxidation catalyst, and/or a chelating agent.

The oxidizing agent may include one or more selected from the group consisting of hydrogen peroxide, urea peroxide, urea, percarbonate, periodate, periodate salts, perchloric acid, perchlorate salts, perbromic acid, perbromate salts, perboric acid, perborate salts, permanganic acid, permanganate salts, persulfate salts, bromate salts, chlorate salts, chlorite salts, chromate salts, iodate salts, iodic acid, ammonium peroxydisulfate, benzoyl peroxide, calcium peroxide, barium peroxide, sodium peroxide, and peroxides. However, the oxidizing agent is not limited thereto.

The oxidizing agent may be included in an amount ranging from 1 wt % to 10 wt %, 1 wt % to 8 wt %, or 3 wt % to 7 wt % of the total weight of the polishing slurry composition. If the oxidizing agent is included in an amount exceeding this range, excessive oxidation of the metal film surface may lead to a decrease in surface planarity. Conversely, if the oxidizing agent is included in an amount below this range, insufficient oxidation of the metal may result in a reduced polishing rate.

The oxidation catalyst may be a complex of one or more metals selected from the group consisting of Fe, Mn, Co, Ce, Ru, Os, Rh, Ir, Ni, Pd, Pt, Cu, Ag, and Au. In one embodiment of the present disclosure, the oxidation catalyst may be an Fe complex, but it is not limited thereto.

The complex may be an ammonium salt, potassium salt, or sodium salt containing one to four functional groups selected from carbonate, gluconate, sulfonate, or phosphate. Additionally, the complex may be an ammonium salt, potassium salt, or sodium salt of Fe containing two carbonate groups, but it is not limited thereto.

The oxidation catalyst may be included in an amount ranging from 0.01 wt % to 0.5 wt % of the total weight of the polishing slurry composition, for example, 0.01 wt % to 0.3 wt %, 0.01 wt % to 0.1 wt %, or 0.01 wt % to 0.05 wt %.

The chelating agent may include one or more selected from the group consisting of gluconic acid, citric acid, tartaric acid, lactic acid, oxalic acid, ascorbic acid, acetic acid, their sodium salts, their potassium salts, and/or their ammonium salts.

FIG. 23 is a conceptual diagram illustrating the anisotropic arrangement of Janus abrasive particles in a chemical mechanical polishing slurry composition according to an embodiment of the present disclosure.

Referring to FIG. 23, the polishing slurry composition 10 may be provided on a polishing pad PD of a chemical mechanical polishing device CMPD. The polishing slurry composition 10 may include Janus abrasive particles 100 and a solvent 101.

The chemical mechanical polishing device CMPD may include a head (not shown) to which a polishing target TG to be polished is mounted and a polishing pad PD that rotates in the same direction as the head. The slurry composition 10 may be supplied between the polishing target TG and the polishing pad PD. The chemical mechanical polishing device CMPD may further include a nozzle (not shown) for delivering the polishing slurry composition 10 between the polishing target TG and the polishing pad PD.

The polishing target TG to be polished may be mounted on the head (not shown) by surface tension or vacuum. While the polishing slurry composition 10 is interposed between the polishing target TG and the polishing pad PD, the head (not shown) may perform rotational and oscillatory motion, while the polishing pad PD may perform rotational motion, thereby polishing the polishing target TG. The head (not shown) may apply a constant pressure P to press the target TG against the polishing pad PD. Additionally, due to the weight of the head (not shown) and the applied pressure, the surface of the polishing target TG and the polishing pad PD may come into contact, allowing the polishing slurry composition 10 to flow between the contact surfaces.

Accordingly, mechanical removal action may be performed by the Janus abrasive particles 100 within the polishing slurry composition 10. Additionally, chemical removal action on the surface of the polishing target TG may be performed by the chemical components in the polishing slurry composition 10. If the polishing target TG has a topographical variation, contact between the Janus abrasive particles 100 and the polishing target TG may initially occur at the protruded portion PR. Pressure may be concentrated on the protruded portion PR, resulting in a relatively higher surface removal rate than in other areas. As the processing continues, the protruded portion PR may be uniformly removed across the entire surface.

The upper surface of the polishing pad PD may be positioned to face the polishing target TG with the polishing slurry composition 10 in between. The Janus abrasive particles 100 in the polishing slurry composition 10 may be provided on the polishing pad PD. At this time, the Janus abrasive particles 100 may have either hydrophilic or hydrophobic regions, and the arrangement direction of each particle may vary depending on whether the polishing pad PD is hydrophilic or hydrophobic.

The hydrophilic region of the Janus abrasive particles 100 may be attracted to the hydrophilic polishing pad PD, while the hydrophobic region may be attracted to the hydrophobic polishing pad PD.

If the polishing pad PD exhibits hydrophilicity, the exposed hydrophilic region of the Janus abrasive particles 100 may directly contact the polishing pad PD. As a result, the hydrophobic region of the Janus abrasive particles 100 may be positioned away from the surface of the polishing pad PD. In this case, the Janus abrasive particles 100 may be arranged such that their hydrophilic region contacts the polishing pad PD, while the exposed hydrophobic region is directed away from the polishing pad PD.

During the polishing process, rotational motion of the Janus abrasive particles 100 may occur. While the individual orientations of the Janus abrasive particles 100 may not be perfectly maintained, they may exhibit a significant degree of alignment due to their high surface-area-to-volume ratio.

In particular, the Janus abrasive particles 100 may exhibit attractive forces between similarly coated regions (e.g., attraction between the first coating portions 130A of different particles, see FIG. 1, and the first coating portions 130B, see FIG. 14). As a result, the Janus abrasive particles 100 may exhibit a meaningful degree of directional alignment compared to randomly arranged conventional abrasive particles.

When a portion of the Janus abrasive particles 100, such as the exposed first coating portion 130A (see FIG. 1), is oriented toward the polishing target TG, the polishing efficiency for the polishing target TG may be enhanced. For example, if the first coating portion 130A (see FIG. 1) is formed using ceria, which exhibits a polishing selectivity between silicon oxide and silicon nitride, orienting the first coating portion 130A toward the polishing target TG may significantly increase the polishing etch rate.

As described above, by coating the cocoon particle 110A (see FIG. 1) or the core particle 110B (see FIG. 14) with materials having different properties, such as hydrophilic or hydrophobic materials, the Janus abrasive particles 100 may be anisotropically arranged on the polishing pad PD. By performing polishing in this aligned state, the polishing efficiency for a specific polishing target TG may be improved.

While example embodiments have been shown and described above, it will be apparent to those skilled in the art that modifications and variations could be made without departing from the scope of the present inventive concept as defined by the appended claims.

What is claimed is:

1. A Janus abrasive particle comprising:
a cocoon particle; and
a first coating portion,
wherein
the cocoon particle comprises a first region on a surface of the cocoon particle and a second region different from the first region, and
the first coating portion is located on the first region of the cocoon particle and comprises a material different from a material of the cocoon particle.

2. The Janus abrasive particle of claim 1, wherein
at least one of the cocoon particle or the first coating portion comprises silica, zirconia, titania, ceria, alumina, a surface-modified inorganic oxide particle, or combinations thereof.

3. The Janus abrasive particle of claim 1, wherein
at least one of the cocoon particle or the first coating portion comprises a pyroelectric material.

4. The Janus abrasive particle of claim 1, wherein
at least one of the cocoon particle or the first coating portion comprises hydroxyapatite, barium titanate, bismuth ferrite, potassium niobate, dibutylammonium perrhenate, lead zirconate, lead titanate, triglycine sulfate, lithium tantalate, lithium niobate, polyvinylidene fluoride, polyvinylidene fluoride-trifluoroethylene copolymer, erbium-doped polyvinylidene fluoride, polyvinylidene fluoride-methylammonium lead iodide, fluorapatite and gelatin mixture, polyvinyl chloride, polyacrylonitrile, hafnium oxide, or combinations thereof.

5. The Janus abrasive particle of claim 1, wherein
the cocoon particle comprises a magnetic material, a photocatalytic material, and/or a piezoelectric material.

6. The Janus abrasive particle of claim 1, wherein
the cocoon particle comprises a plurality of particles combined with each other, and
at least some of the plurality of particles have a dendrite structure.

7. The Janus abrasive particle of claim 1, wherein
the cocoon particle comprises a plurality of particles combined with each other, and
at least some of the plurality of particles comprise a material different from a material of remaining particles.

8. The Janus abrasive particle of claim 1, wherein
at least one of the cocoon particle or the first coating portion comprises a pyroelectric material, and
the cocoon particle comprises a piezoelectric material.

9. The Janus abrasive particle of claim 1, wherein
the Janus abrasive particle further comprises a second coating portion on an entire surface of the Janus abrasive particle or the second region of the cocoon particle, and
the second coating portion comprises a material different from a material of the cocoon particle.

10. The Janus abrasive particle of claim 1, wherein
the Janus abrasive particle further comprises a third coating portion on the second region of the cocoon particle, and
the third coating portion comprises a material different from a material of the cocoon particle.

11. The Janus abrasive particle of claim 10, wherein
the third coating portion comprises a magnetic material.

12. A Janus abrasive particle comprising:
a core particle having a dendrite structure; and
a first coating portion on a first region on a surface of the core particle,
wherein
the first coating portion comprises a material different from a material of the core particle.

13. The Janus abrasive particle of claim 12, wherein
the Janus abrasive particle further comprises a second coating portion on an entire surface of the Janus abrasive particle or a second region different from the first region of the core particle.

14. The Janus abrasive particle of claim 13, wherein
the second coating portion comprises a surface-modified inorganic oxide, and
the surface-modified inorganic oxide is provided as a composite comprising any one of a cationic polymer, an anionic polymer, or a non-ionic polymer.

15. The Janus abrasive particle of claim 12, wherein
at least one of the core particle or the first coating portion comprises silica, zirconia, titania, ceria, alumina, a surface-modified inorganic oxide particle, or combinations thereof.

16. The Janus abrasive particle of claim 12, wherein
at least one of the core particle or the first coating portion comprises a pyroelectric material.

17. The Janus abrasive particle of claim 12, wherein
at least one of the core particle or the first coating portion comprises hydroxyapatite, barium titanate, bismuth ferrite, potassium niobate, dibutylammonium perrhenate, lead zirconate, lead titanate, triglycine sulfate, lithium tantalate, lithium niobate, polyvinylidene fluoride, polyvinylidene fluoride-trifluoroethylene copolymer, erbium-doped polyvinylidene fluoride, polyvinylidene fluoride-methylammonium lead iodide, fluorapatite and gelatin mixture, polyvinyl chloride, polyacrylonitrile, hafnium oxide, or combinations thereof.

18. The Janus abrasive particle of claim 12, wherein
the core particle comprises:
a core comprising a magnetic material; and
a shell surrounding a surface of the core and comprising a pyroelectric material having a dendrite structure.

19. The Janus abrasive particle of claim 12, wherein
the first coating portion covers 50% or more to less than 100% of a surface of the core particle.

20. A slurry composition for chemical mechanical polishing, the slurry composition comprising:
Janus abrasive particles, each of which has either a cocoon shape or a single fine particle shape; and
a solvent in which the Janus abrasive particles are dispersed,
wherein
the Janus abrasive particles having the cocoon shape each comprising:
a cocoon particle formed by combining a plurality of particles; and
a first coating portion on at least a portion of the cocoon particle
and comprising a material different from a material of the cocoon particle, and
the Janus abrasive particles having the single fine particle shape each comprising:
a core particle having a dendrite structure and comprising a pyroelectric material; and
an abrasive particle on at least a portion of the core particle and comprising a material different from the material of the core particle.
